(19) United States
(12) Patent Application Publication
(10) Pub. No.: US 2021/0331900 A1
(43) Pub. Date: Oct. 28, 2021

(54) Roof-Mounted Building Access System

(71) Applicant: Gregory L. Beeche, Mechanicville, NY (US)

(72) Inventor: Gregory L. Beeche, Mechanicville, NY (US)

(21) Appl. No.: 17/236,470

(22) Filed: Apr. 21, 2021

Related U.S. Application Data
(60) Provisional application No. 63/101,274, filed on Apr. 22, 2020.

(51) Int. Cl. B66C 23/26; B66C 23/84; B66C 23/66

(52) U.S. Cl. CPC B66C 23/26; B66C 23/66; B66C 23/84

(57) ABSTRACT

An improved building access system includes a turntable having an upper surface and a lower surface, a main tower attached to the turntable's upper surface, a boom tower pivotally attached to the turntable and disposed so as to form an angle with the main tower, and a balancing tower also pivotally attached to the turntable and also disposed so as to form an angle with the main tower. It also includes means for changing these angles between the main tower and, respectively, the boom tower and the balancing tower, and a cathead pivotally attached to the end of the boom tower which is opposite the end attached to the turntable. The inventive apparatus also includes pressure sensing devices located and disposed so as to measure the pressure at each mounting point where the main tower is attached to the turntable, along with one or more leveling rods disposed so that, as the boom tower is raised upwardly and the angle between the main tower and the boom tower decreases in value by an associated amount, the angle between the cathead and the boom tower decreases in value by the same amount. The turntable may further include at least one support arm configured so that the bending forces experienced by the turntable are transferred to a larger diameter support structure. The invention also includes an elongated beam member which is especially useful for forming box beams, which member has a pair of symmetrical planar side elements which are perpendicular to each other and which are also connected together by a diagonal element.

### CROSS REFERENCE TO RELATED APPLICATIONS

This application is related to, and claims priority to and the benefit of, provisional application No. 63/101,274, filed on Apr. 22, 2020.

### STATEMENT OF FEDERALLY SPONSORED RESEARCH OR DEVELOPMENT

Not Applicable

### NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not Applicable

### REFERENCE TO A SEQUENCE LISTING, A TABLE, OR A COMPUTER PROGRAM LISTING APPENDIX

Not Applicable

### FIELD OF THE INVENTION

This invention relates to structural assemblies and components which are useful in the construction and maintenance of buildings or other structures. In particular, the invention is directed to a roof-mounted assembly which provides improved access to all portions of the exterior of such structures, with minimal interruption required to move the assembly or to include hoisting of materials. The assembly may additionally be formed from modular components which allow the assembly to provide varying span, strength, and rigidity characteristics which match the requirements of a particular application.

### BACKGROUND OF THE INVENTION

While building or maintaining various structures, and particularly tall buildings, it is often necessary to access the outside of the structure to either install building components (for example, façade materials) or to perform maintenance or refurbishing tasks on components already there. Historically, this required access was provided by the type of scaffolding which is based at ground level, and then is built upward to reach the height needed. Such scaffolding systems have typically been employed in close proximity to the building or structure being worked on, in order to provide artisans with a suitable area from which to perform their tasks. In the past, these scaffolding systems were constructed by bolting together vertical and horizontal members, and were usually not movable. They therefore allowed access to only one portion of the building or structure at a time. To move on to the next portion of the building, it was usually necessary to disassemble the scaffolding system, relocate its base, and then reassemble the members involved.

In addition to requiring a considerable amount of time and energy to dismantle and reassemble the scaffold each time it was moved, these prior art systems also presented significant safety risks to the workers using them. In addition, for most of these prior art scaffolding systems, the vertical height of the work platform could not be raised or lowered without dismantling a substantial portion of the scaffolding system. And, of course, for tall buildings, such scaffolding can quickly amount to an excessive amount of elements, and can be of questionable integrity and stability. Additionally, this traditional type of scaffolding doesn't provide enough strength to allow it to be used for lifting materials and components from the ground level to the height needed for the required installation or maintenance.

Another problem that has become prevalent in modern construction and maintenance activities is the need for scaffolding systems which are readily adaptable in size and shape, and which can be easily configured to accommodate a variety of accessories. As the pace of building construction has increased, and the time available for completing each task has correspondingly decreased, such scaffolding systems have become key elements in the construction process. The variety and complexity of building shapes and structures has increased dramatically in recent years. Designing and fabricating customized scaffolding systems to fit particular building shapes and to accommodate particular tasks can be both time consuming and relatively expensive. Contemporary scaffolding systems must therefore be adaptable for use in many configurations and applications. The assembled platforms must also have sufficient span strength and torsional rigidity to safely hold both the workers using the scaffolding and their materials.

Over time, several new approaches have been utilized to attempt to solve these problems. Cranes with very long booms have been used with limited utility and with limitations on the loads they can safely lift. Then, more creative minds (like that of the present inventor) discerned that more efficient, safer, and higher capacity lifting and access could be provided by suspending men and materials from the top of the structure downward, thereby utilizing higher strength tensile forces. Use of wire ropes and pulleys and horizontal beams facilitated moving men and materials up and down the outside of a structure.

Recently, several scaffolding system improvements have been disclosed which alleviate a number of the problems noted above. U.S. Pat. No. 4,234,055, issued to G. L. Beeche on Nov. 18, 1980, describes a mobile suspension scaffold which requires assembly and dismantling only once for each construction site, at the beginning and the end of the job, respectively. The system described may be moved along the sides of a building and around building corners without being disassembled. A suspended scaffold system which may be used either independently or in conjunction with this mobile scaffold is the folding scaffold described in U.S. Pat. No. 4,253,548, issued to G. L. Beeche on Mar. 3, 1981. The system disclosed therein includes a plurality of work platforms which are foldably linked together. U.S. Pat. No. 4,967,875, issued to G. L. Beeche on Nov. 6, 1990, describes a scaffolding system which employs modular components that may be combined to readily provide a variety of scaffold configurations and sizes. U.S. Pat. No. 5,203,428, issued to G. L. Beeche on Apr. 20, 1993, in turn discloses a scaffolding platform comprised of connected truss frames, which platform is particularly useful in conjunction with the scaffolding system disclosed by U.S. Pat. No. 4,967,875, and which may also be used independently thereof. The scaffold platform set forth in U.S. Pat. No. 5,203,428 is itself modular in nature, thereby further facilitating the assembly of scaffolding platforms which can conform to nearly any building size or shape. U.S. Pat. No. 5,214,899, issued to Beeche et al. on Jun. 1, 1993, describes a truss frame that is assembled from lightweight, modular components which are designed so as to provide the assembled frame with exceptional strength and rigidity. Finally, U.S. Pat. No. 8,347,580 issued to Beeche on Jan. 8, 2013, discloses a new structural member and modular beam system that provides improved strength, rigidity, and utility for building access assemblies.

What is needed, then, is a building access system which allows construction and maintenance workers to perform their tasks on all portions of the building's exterior, at any height between ground level and the top of the building, with minimal interruption to allow movement of the apparatus from one location to another. The desired system should, at the same time, be usable for lifting and placing the needed materials in the locations required for these workers to perform their tasks.

Accordingly, it is an object of the present invention to provide improved access to all portions of the exterior of a building or structure.

It is a further object to provide such access without needing to disassemble and reassemble, or to otherwise re-configure, the access assembly.

It is another object of the invention to provide a system which can also be used to lift, lower, and place in position objects other than workers, such as building components and materials.

It is an additional object of the present invention to provide an access system which can be assembled in a modular fashion, in order to accommodate varying requirements for size, strength, torsional rigidity, etc.

### BRIEF SUMMARY OF THE INVENTION

The building access system of the present invention comprises a turntable having an upper surface and a lower surface, a main tower attached to the turntable's upper surface, a boom tower pivotally attached to the turntable and disposed so as to form an angle with the main tower, and a balancing tower also pivotally attached to the turntable and also disposed so as to form an angle with the main tower. It further comprises means for changing these angles between the main tower and, respectively, the boom tower and the balancing tower, and a cathead pivotally attached to the end of the boom tower which is opposite the end attached to the turntable. The inventive apparatus may further comprise pressure sensing devices located and disposed so as to measure the pressure at each mounting point where the main tower is attached to the turntable, along with one or more leveling rods disposed so that, as the boom tower is raised upwardly and the angle between the main tower and the boom tower decreases in value by an associated amount, the angle between the cathead and the boom tower decreases in value by the same amount. The turntable may further comprise at least one support arm configured so that the bending forces experienced by the turntable are transferred to a larger diameter support structure. The invention also includes an elongated beam member which is especially useful for forming box beams, which member has a pair of symmetrical planar side elements which are perpendicular to each other and which are also connected together by a diagonal element. The inventive apparatus may be assembled using components which are small enough to fit in a building's elevator or stairway in order to move them from the ground level to the top of the structure, and light enough to be carried by manpower alone.

### BRIEF DESCRIPTION OF THE DRAWINGS

The subject matter which is regarded as the invention is particularly pointed out and distinctly claimed in the concluding portion of the specification. The invention itself, however, both as to its organization and its method of practice, together with further objects and advantages thereof, may best be understood by reference to the following description taken in conjunction with the accompanying drawings, in which:

FIG. 1 is a side-elevational view of one embodiment of the improved building access system of the present invention;

FIG. 2A is a side-elevational view of a similar embodiment, with annotations thereon indicating the locations of the detailed views shown in FIGS. 2B and 2C;

FIG. 2B and FIG. 2C are, respectively, side-elevational and plan views of the details annotated in FIG. 2A;

FIG. 3 is a another side-elevational view of the embodiment shown in FIG. 1, illustrating the coordinated movement of the boom tower and the balancing tower in accordance with the present invention;

FIG. 4 is an elevational view of one embodiment of the tower assemblies included in the instant invention;

FIG. 5 is an elevational view which illustrates the manner in which the components of the inventive apparatus may be assembled by workmen;

FIG. 6 is a side-elevational view of one embodiment of the turntable included in the present invention;

FIG. 7A is a side-elevational view showing further details of the turntable illustrated in FIG. 6;

FIG. 7B is a plan view in partial cross-section of the assembly shown in FIG. 7A, taken along line B-B;

FIG. 7C is a plan view of the assembly shown in FIG. 7A, taken along line A-A;

FIG. 8 is an elevational view in partial cross-section of one embodiment of the slewing ring in accordance with the invention;

FIG. 9A is a front-elevational view of one embodiment of the cathead included in the instant invention;

FIG. 9B is a plan view of the cathead shown in FIG. 9A;

FIG. 10 is an elevational view in partial cross-section showing further details of one embodiment of the cathead slewing ring bearing, in accordance with the invention;

FIG. 11A, FIG. 11B, and FIG. 12 are elevational views which, together, schematically illustrate how items can be transferred to the basket attached to the cathead of the inventive building access system, and the manner in which multiple baskets may be arranged in a horizontal orientation, in accordance with the invention;

FIG. 13 is an elevational view similar to that of FIG. 12, schematically illustrating one embodiment for utilizing multiple cathead baskets arranged in both horizontal and vertical orientations;

FIG. 14 and FIG. 15 are elevational views schematically illustrating one embodiment of a cathead basket which provides for movement of a suspended item within the basket, as the item is transferred to the location where it is to be installed or otherwise used by workmen;

FIG. 16 is an elevational view schematically illustrating an embodiment of the inventive access system which additionally provides for switching the cathead hoist system from raising and lowering the basket to raising and lowering other load items;

FIG. 17 schematically illustrates one embodiment of a beam element which is particularly useful for constructing any one or all of the main tower, the boom tower, and the balancing tower of the inventive access system;

FIG. 18 schematically illustrates an embodiment of the invention in which four beam elements are configured so as to form a box beam;

FIG. 19 schematically illustrates several embodiments of suitable means for fastening together multiple ones of the inventive beam element, so as to form a box beam;

FIG. 20 schematically illustrates one embodiment of the inventive box beam which is particularly useful when additional components are to be attached thereto;

FIG. 21 schematically illustrates an embodiment of the inventive beam element which enhances modularity by including a plurality of openings through which fastening means may be inserted;

FIG. 22 is an end view of an embodiment similar to that shown in FIG. 21, further illustrating alternative beam element fastening means and joining items in accordance with the invention;

FIG. 23 schematically illustrates one preferred embodiment of the L-shaped element shown in FIG. 22;

FIG. 24 schematically illustrates an embodiment of the invention in which the beam elements are configured so that the cross-section of the box beam is rectangular rather than square;

FIG. 25 schematically illustrates an alternative embodiment similar to that shown in FIG. 24, in which embodiment the size of the assembled box beam is increased in the width direction instead of the height direction; and

FIG. 26 schematically illustrates yet another embodiment similar to that shown in FIGS. 24 and 25, in which embodiment the size of the assembled box beam is increased in both the width direction and the height direction.

### DETAILED DESCRIPTION OF THE INVENTION

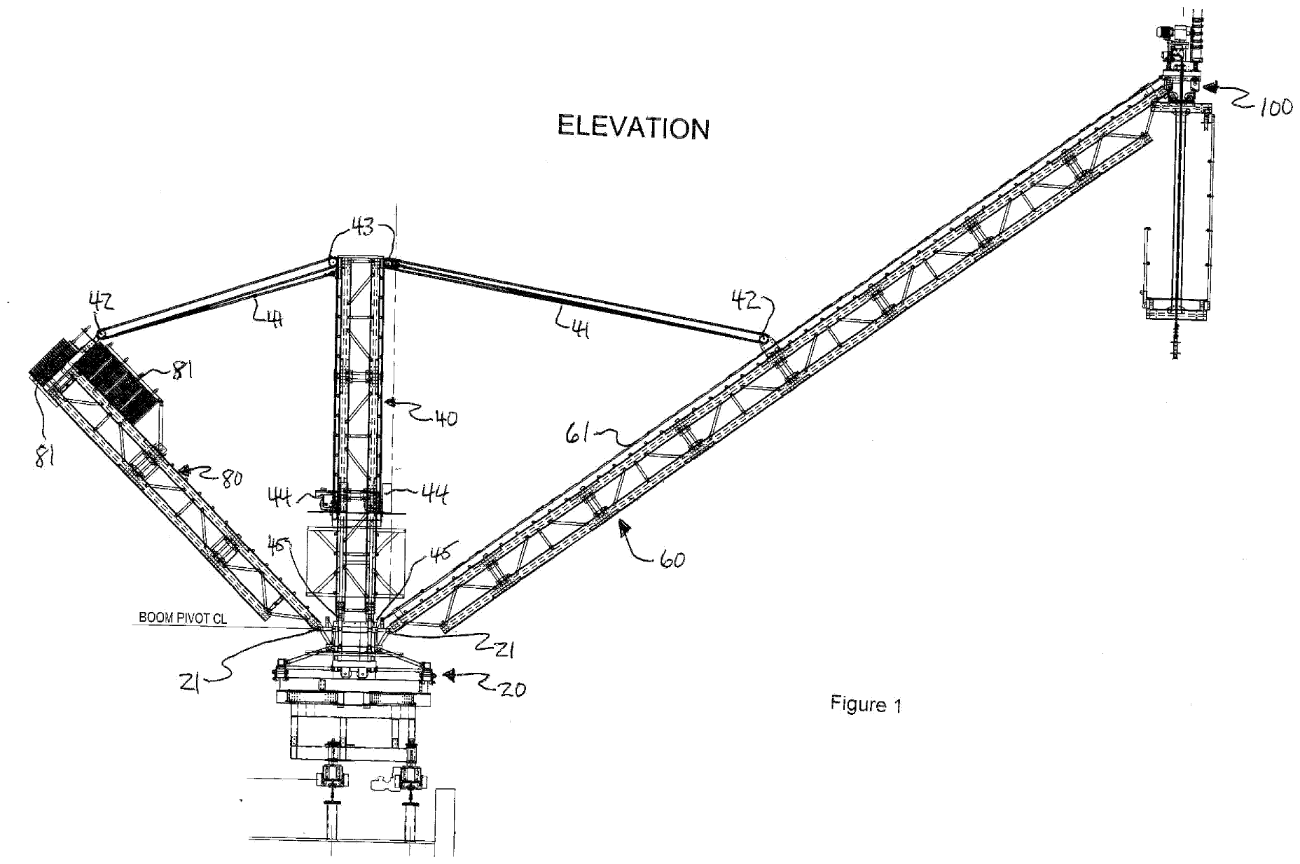

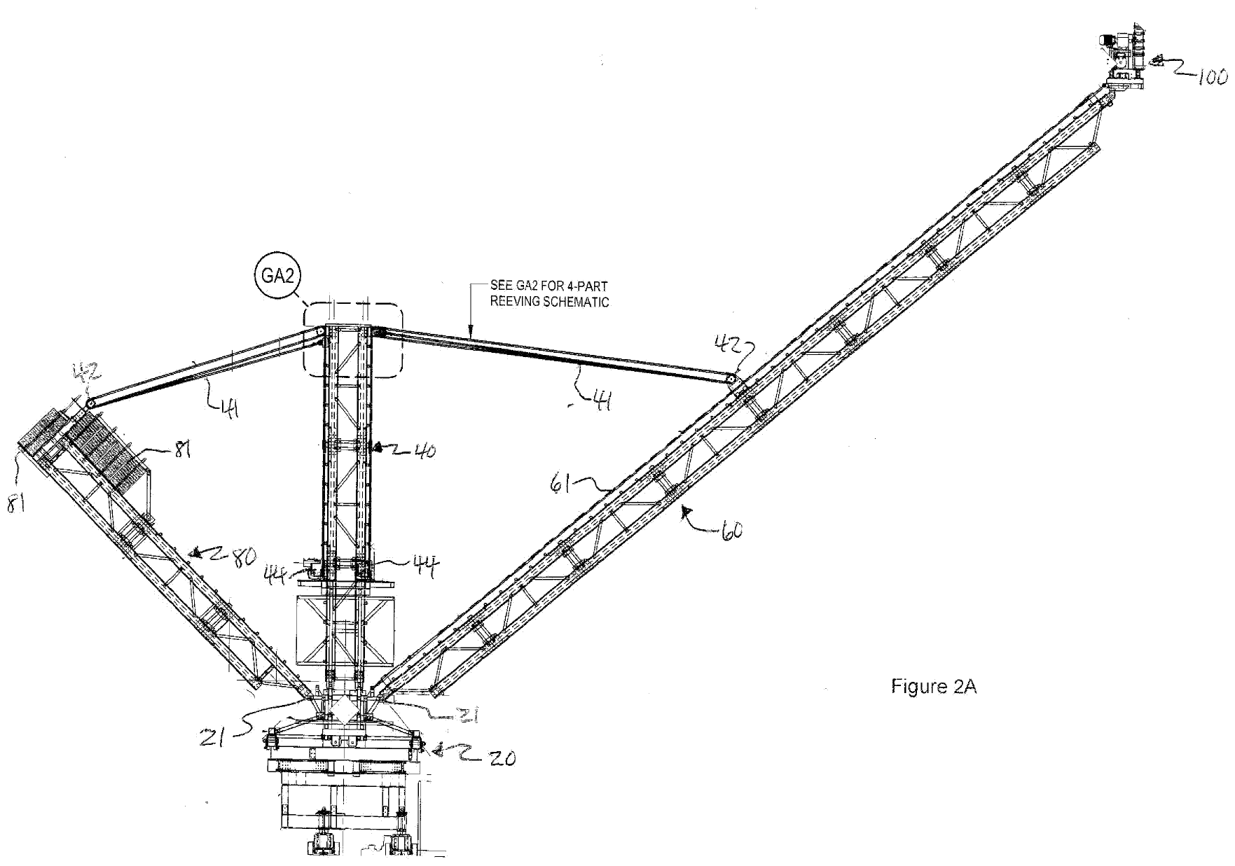

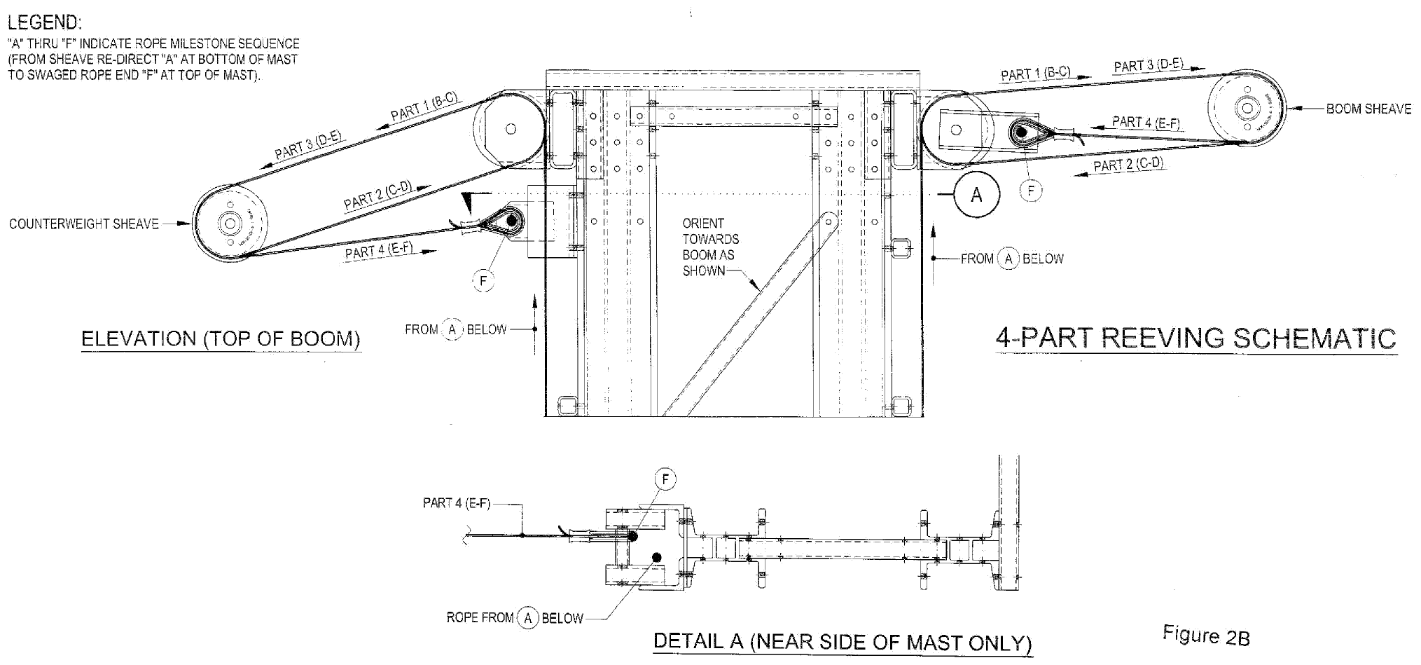

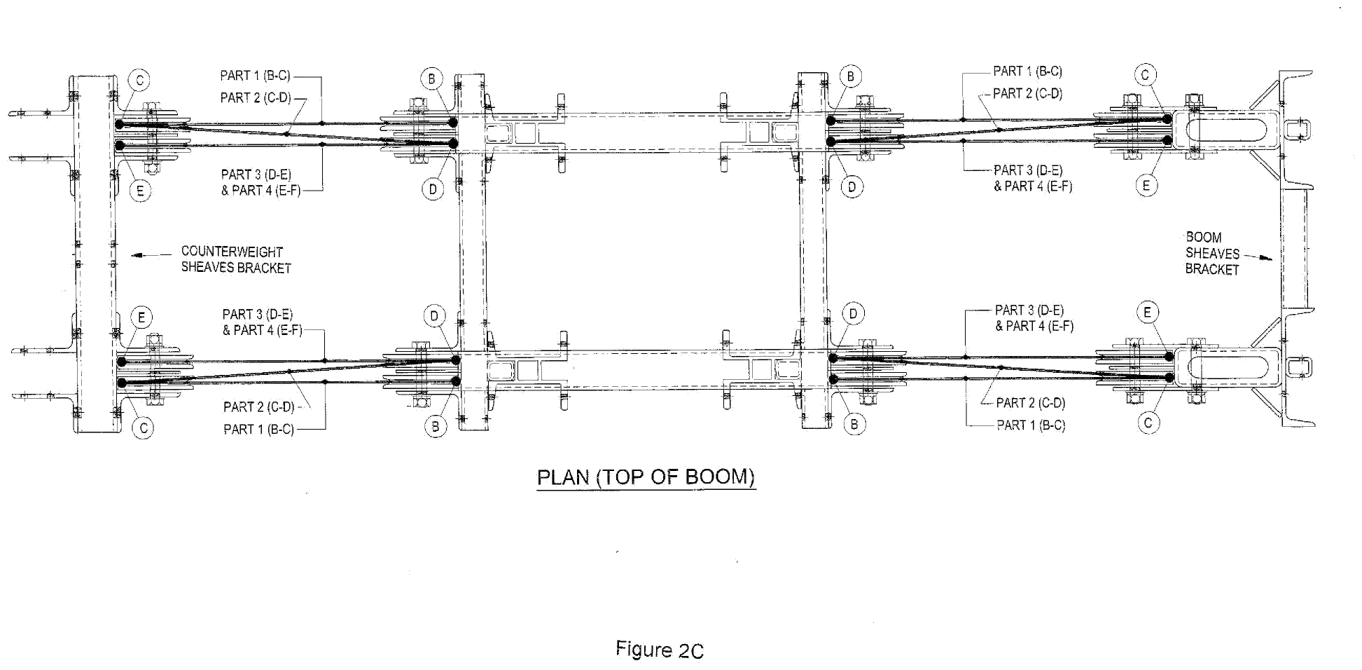

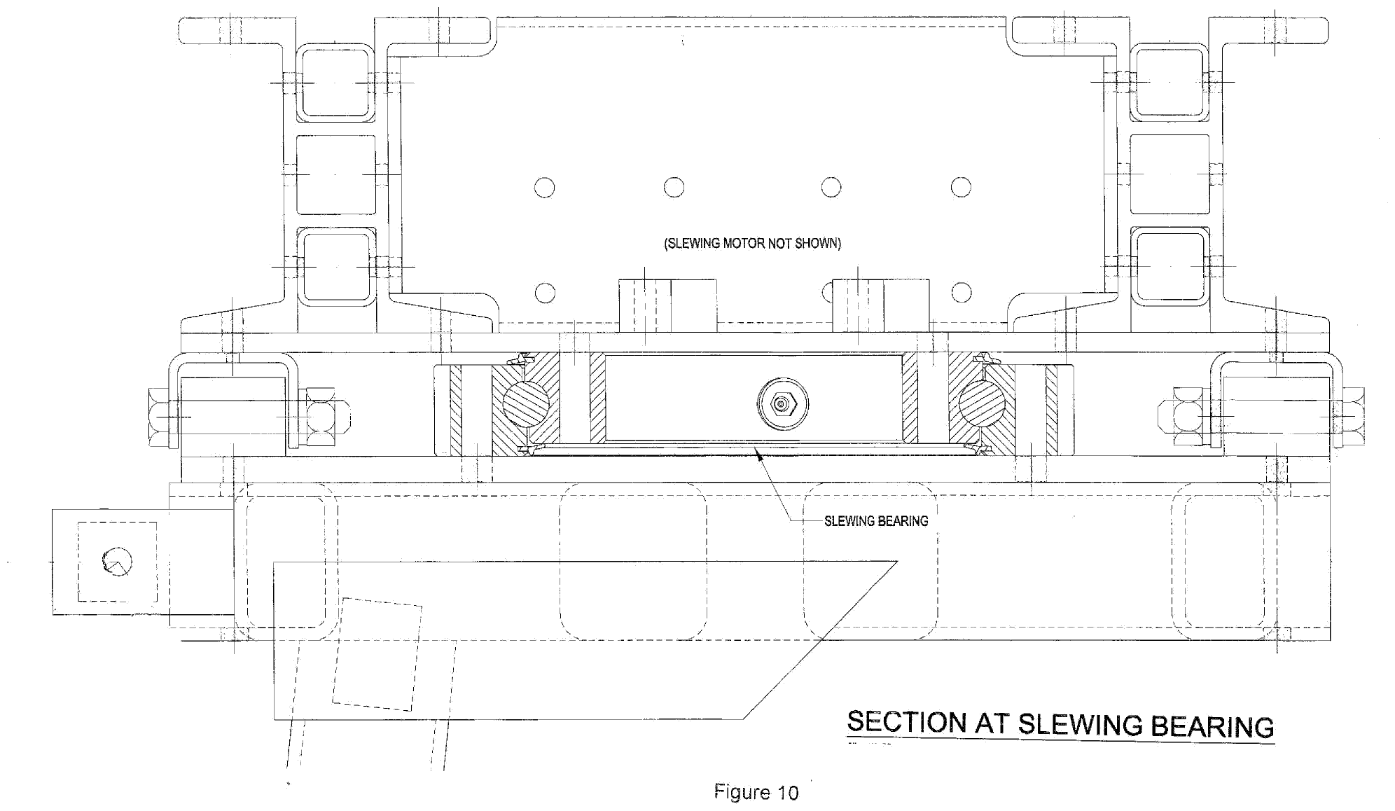

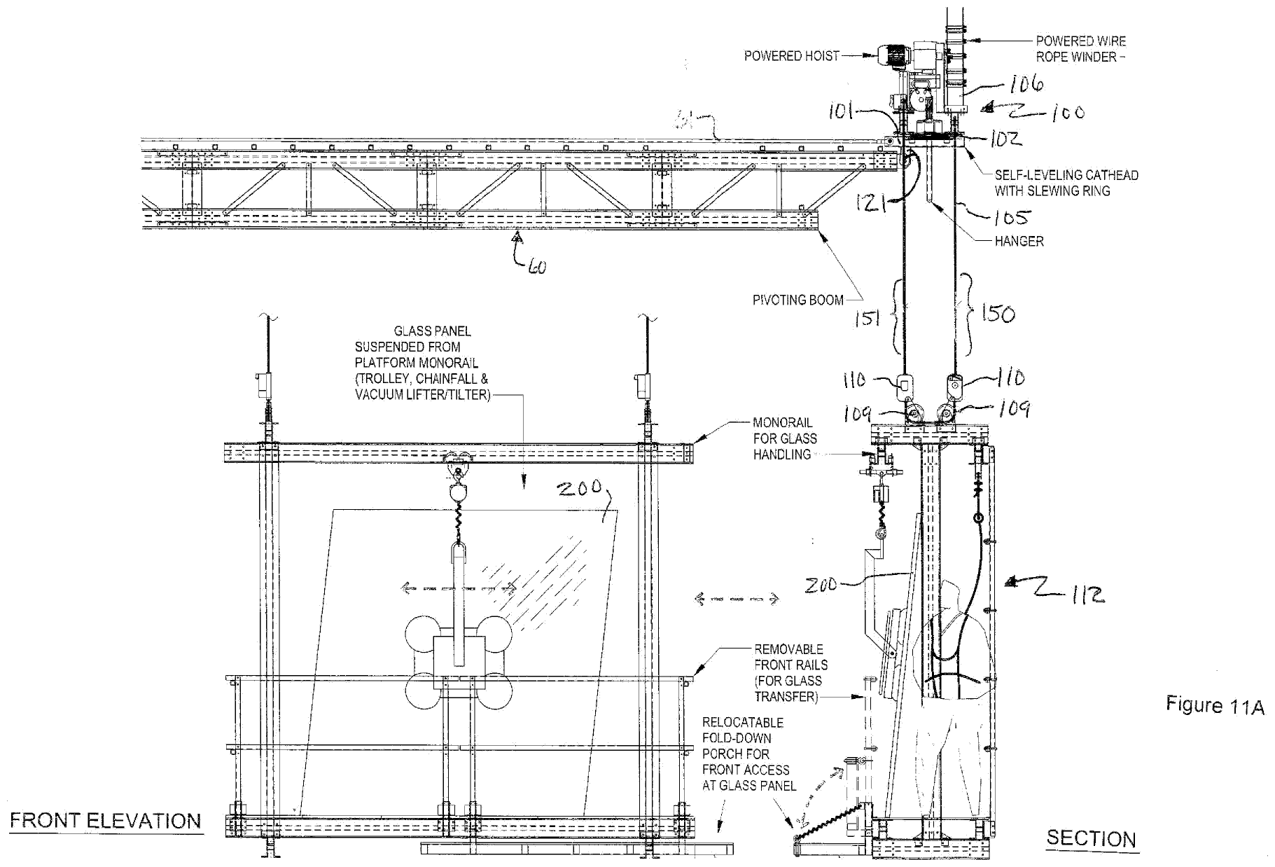

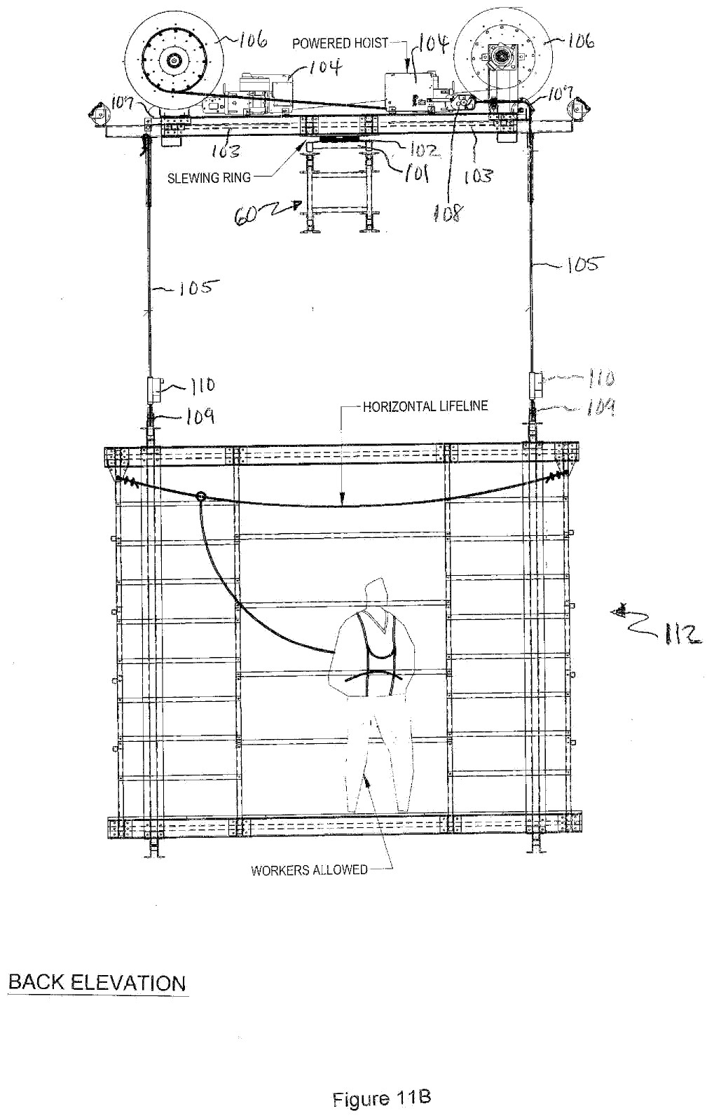

As is schematically illustrated by FIGS. 1-10, the improved building access system of the present invention comprises turntable 20, main tower 40, boom tower 60, balancing tower 80, and cathead 100. Main tower 40 is typically rigidly mounted to turntable 20, whereas boom tower 60 and balancing tower 80 are both pivotally mounted to turntable 20 by means of pivot points 21. The angles between main tower 40 and, respectively, boom tower 60 and balancing tower 80 are changed by means of cables 41, pulleys 42 and sheaves 43 attached to their corresponding towers, and cable winders 44. As the motor of the respective cable winder rotates in one direction to wind cable in, the corresponding tower is raised into a more vertical configuration. Conversely, as the motor of the respective cable winder rotates in the opposite direction to let cable out, the corresponding tower is lowered into a more horizontal configuration. In one embodiment, two sets of these cables, pulleys, and winders are used for each pivoting tower. Although each tower could be raised and lowered using only one cable for each tower, using two cables on each, disposed in a spaced apart relationship, provides additional resistance to twisting forces on each tower. One particularly useful type of cable for this invention is braided wire rope. Additionally, for applications where more mechanical advantage is desired, the 4-part reeving schematic which is illustrated in FIGS. 2A-2C may be employed.

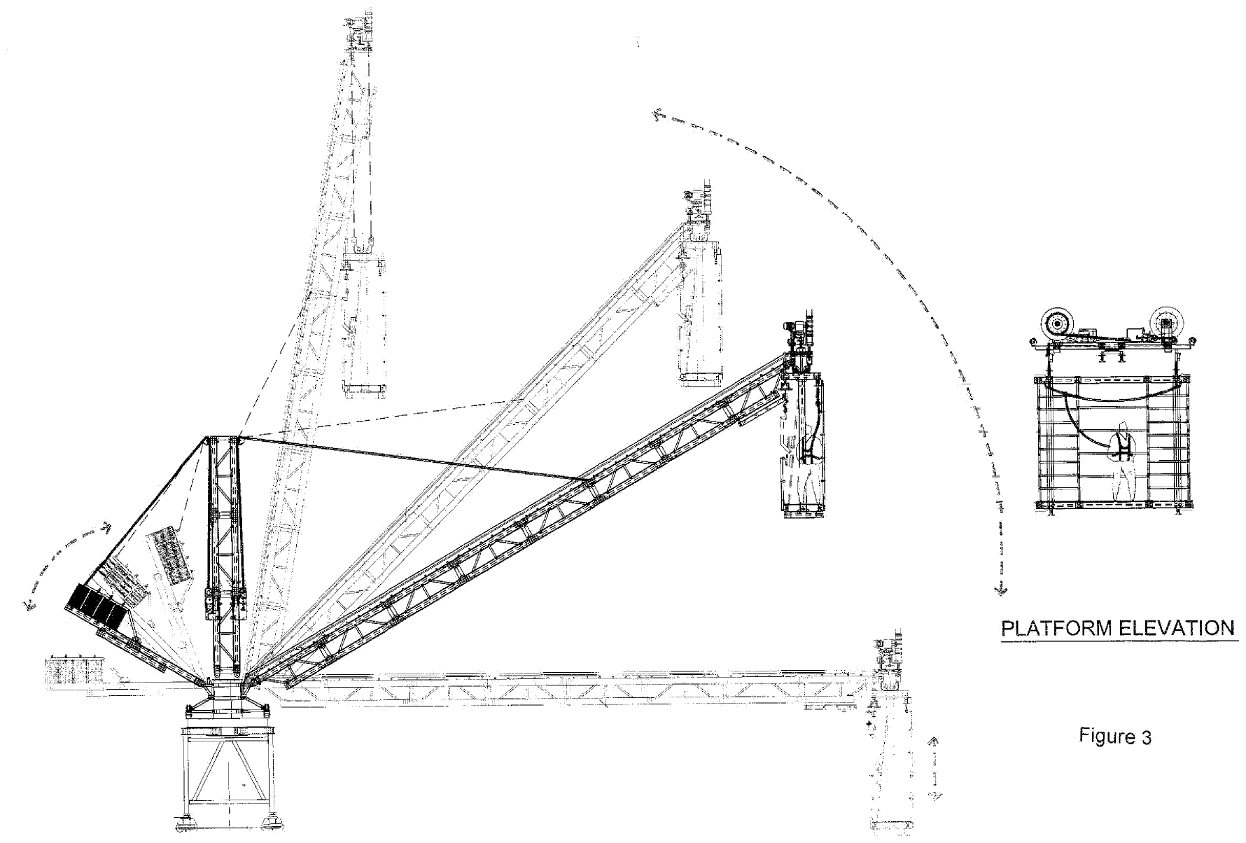

Located between main tower 40 and turntable 20, at each mounting point where main tower 40 is connected to turntable 20, are pressure sensing devices 45 which individually measure the pressure at each such connection. Alternatively, these pressure sensing devices may be located in the turntable assembly. In operation, boom tower 60 is raised or lowered into its desired position for the required work access. Balancing tower 80 has attached thereto sufficient counterweights 81, that balancing tower 80 can be raised or lowered to a position where it counterbalances boom tower 60. It does so by changing the effective length of the moment arm created by counterweights 81. This position is found by monitoring pressure sensing devices 45, and stopping when the pressures measured by said devices are all approximately the same. At that position, the forces on main tower 40 are essentially all in a downward direction, with very little bending force or torsional force on main tower 40. This type of operation and relationship between main tower 40, boom tower 60, and balancing tower 80 is schematically illustrated in FIG. 3, where the solid dark lines show the inventive apparatus with boom tower 60 and balancing tower 80 in one position, and the shaded lines show them in different positions. In each case, the respective positions of boom tower 60 and balancing tower 80 are such that the forces on main tower 40 are balanced and essentially all in a downward direction.

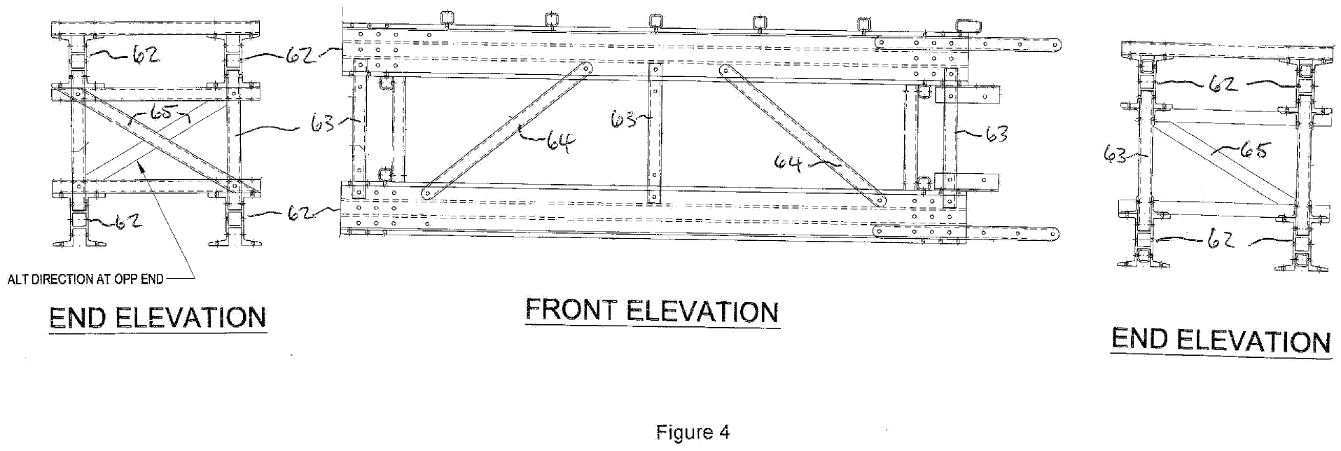

Main tower 40, boom tower 60, and balancing tower 80 may be constructed from any suitable conventional materials. As illustrated in FIG. 4, in one embodiment, main tower 40, boom tower 60, and balancing tower 80 are formed as “box truss” assemblies, with each comprised of the structural members and modular beam system shown in U.S. Pat. No. 8,347,580 issued to Gregory L. Beeche. As described therein, such members are configured so as to provide excellent resistance to bending and torsional forces, and can be assembled from modular components which are light enough and short enough that they may be manually transported from the ground level to the roof of a structure by workers, without the assistance of any lifting equipment. These components will fit through stairways and/or elevators. The modularity of this system allows the same basic components to be arranged in differing configurations, so that each of the three assembled towers provides the length, strength, rigidity, and torsional resistance required for a particular application.

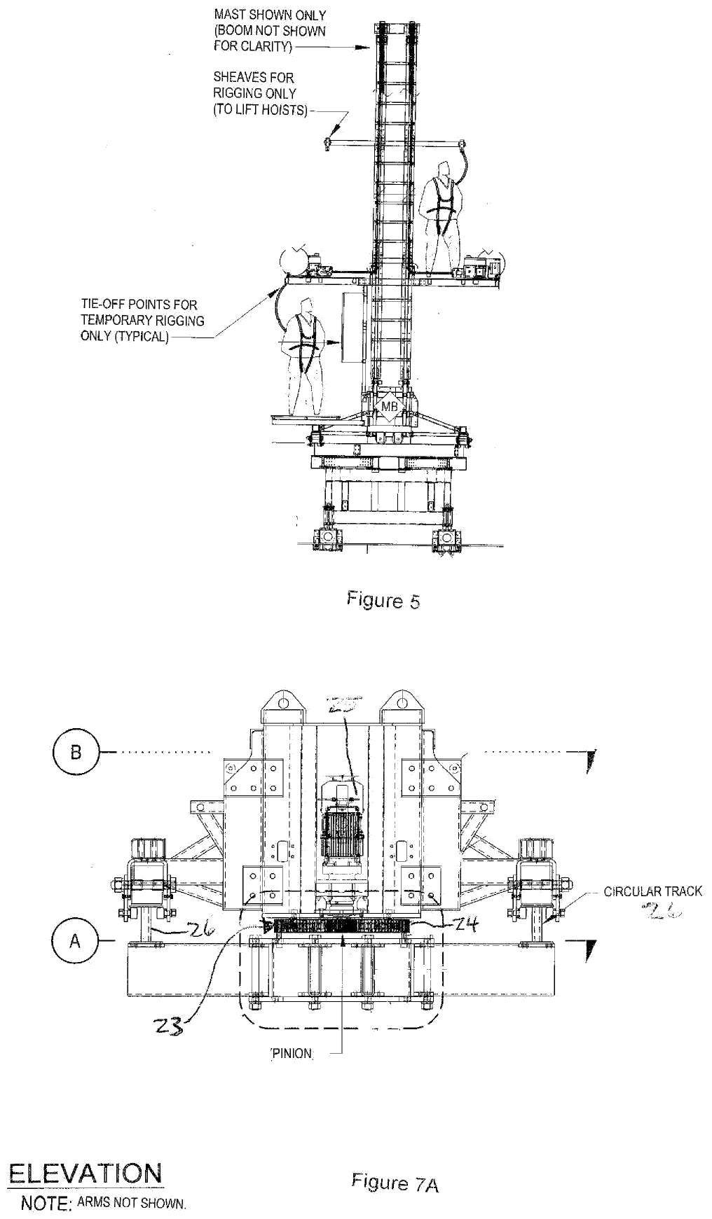

Utilizing the above described modular system also provides the capability of assembling the inventive apparatus without requiring any lifting equipment, using manpower alone, while simultaneously complying with safety guidelines mandated by the Occupational Safety and Health Administration (OSHA) or state and local governments. As schematically illustrated in FIG. 5, the modular components which comprise the turntable section may be brought to the roof level and assembled there, while also securing that section to the building's infrastructure. In a similar fashion, the boom tower and balancing tower sections may be assembled in a horizontal position, with each resting on the building's roof. Next, a portion of the main tower may be assembled, up to a height that is reachable by the person who is assembling it. One or more platforms may then be attached to the side(s) of the assembled portion of the main tower. After climbing up to the platform(s), the worker then repeats the assembly process for the next portion of the main tower. This process is repeated as many times as necessary to complete assembly of the full-height main tower. If necessary to lift heavy items like the cable winders, horizontal arms and accompanying pulleys or sheaves may be attached to the side(s) of the main tower at the desired locations, and these mechanisms may be used to accomplish such lifting tasks. At each level, the worker may safely secure himself to the assembled structure, thereby complying with all applicable safety requirements.

In a typical arrangement, as shown in FIG. 4, structural members 62 are connected together end-to-end in a longitudinal direction. Then, four of these assemblies are connected to each other by cross members 63, each of which is disposed in a perpendicular direction with respect to the longitudinal direction of the four assemblies. For added strength, diagonal members 64 are added, with each such diagonal member running between, and connecting together, two of the four assemblies. In this manner, a “box truss” is formed. For applications requiring further support, diagonal members 65 may be added. The specific number and size of the elements chosen to form the box truss depend on the length and strength needed for the respective tower.

In applications where additional resistance to bending and torsional forces is required, a “post tensioning” technique may be employed with the tower assembly. A wire or cable may be anchored at one longitudinal end of the tower by attaching it to one of the corners of the “box,” and then strung in a diagonal direction to the opposite corner of the adjacent “box” formed by the connected assembly of members, and then strung in the opposite diagonal direction to the opposite corner of the next adjacent “box” formed by the connected assembly of members. This “crisscrossing” type of stringing is continued along the length of the tower, to the opposite longitudinal end. Preferably, at least one more of such wires or cables is similarly anchored at the corner of the end box which is oppositely located to the first cable's anchor point, and then strung similarly in opposite diagonal directions with respect to the first cable, continuing until reaching the opposite longitudinal end of the tower. Once the wires or cables are strung, a pulling force of a predetermined amount is applied to each one before it is anchored to the associated longitudinal end of the tower, so as to create a residual tension in the respective wire or cable. This residual tension serves to resist bending or torsional forces applied to the tower by external loads attached to the tower. Optimally, four such tensioning wires or cables are used, so that this resistance is provided in both directions perpendicular to the tower and both rotational directions. Also, in order to shorten the lengths along the wire or cable which are unanchored, and therefore most likely to be the locations where undesirable stretching of the cable or wire would occur, at each location where the wire or cable crisscrosses another wire or cable, clamps can be added. These clamps will act as anchoring points for both of the clamped wires or cables, and will thereby minimize stretching or slippage of either cable.

At least one fixed length leveling rod 61 is disposed between boom tower 60 and cathead 100, with one end of leveling rod 61 attached to cathead assembly 100 and other end thereof attached to turntable 20. As boom tower 60 is raised upwardly and the corresponding angle between main tower 40 and boom tower 60 decreases in value by an associated amount, the length of leveling rod 61 remains at its fixed distance. As a result, the tab connecting cathead 100 to leveling rod 61 rotates about its pivot point, thereby causing cathead assembly 100 to similarly pivot. The angle between boom tower 60 and the horizontal axis of cathead 100 thereby increases in value by the same amount as the decrease in the angle between main tower 40 and boom tower 60. By this mechanism, the horizontal plane of the cathead always remains level, regardless of upward or downward movement of boom tower 60. Two such leveling rods 61 may be employed, disposed in a spaced apart relationship, in order to provide additional resistance to twisting forces on the cathead.

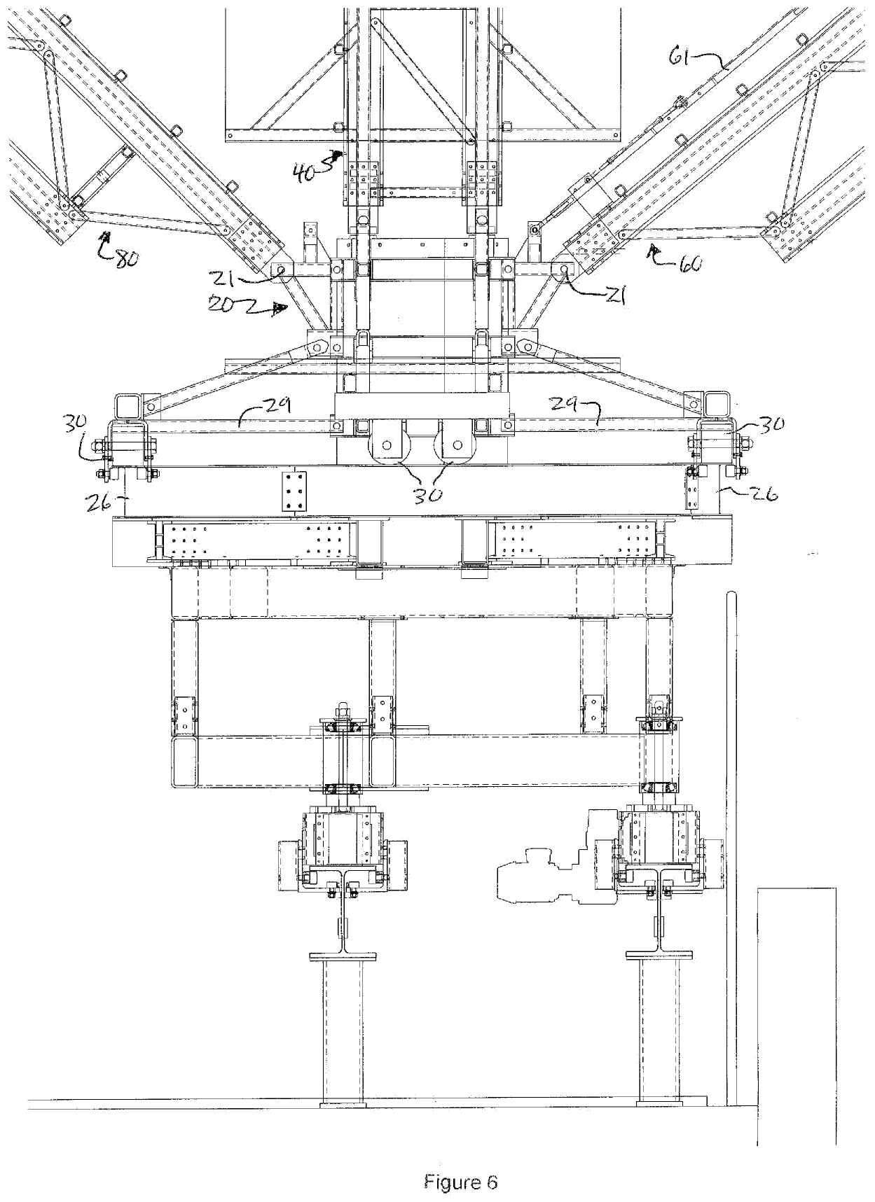

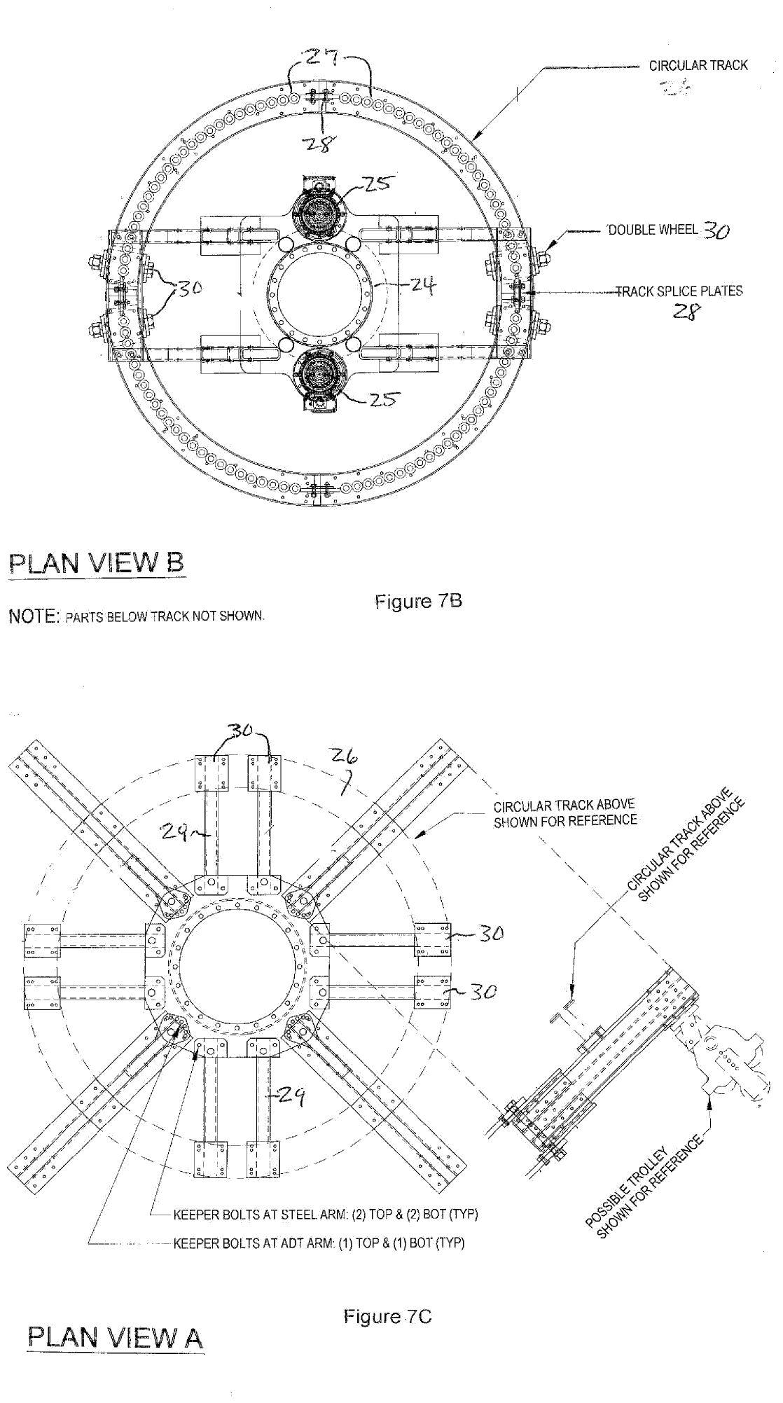

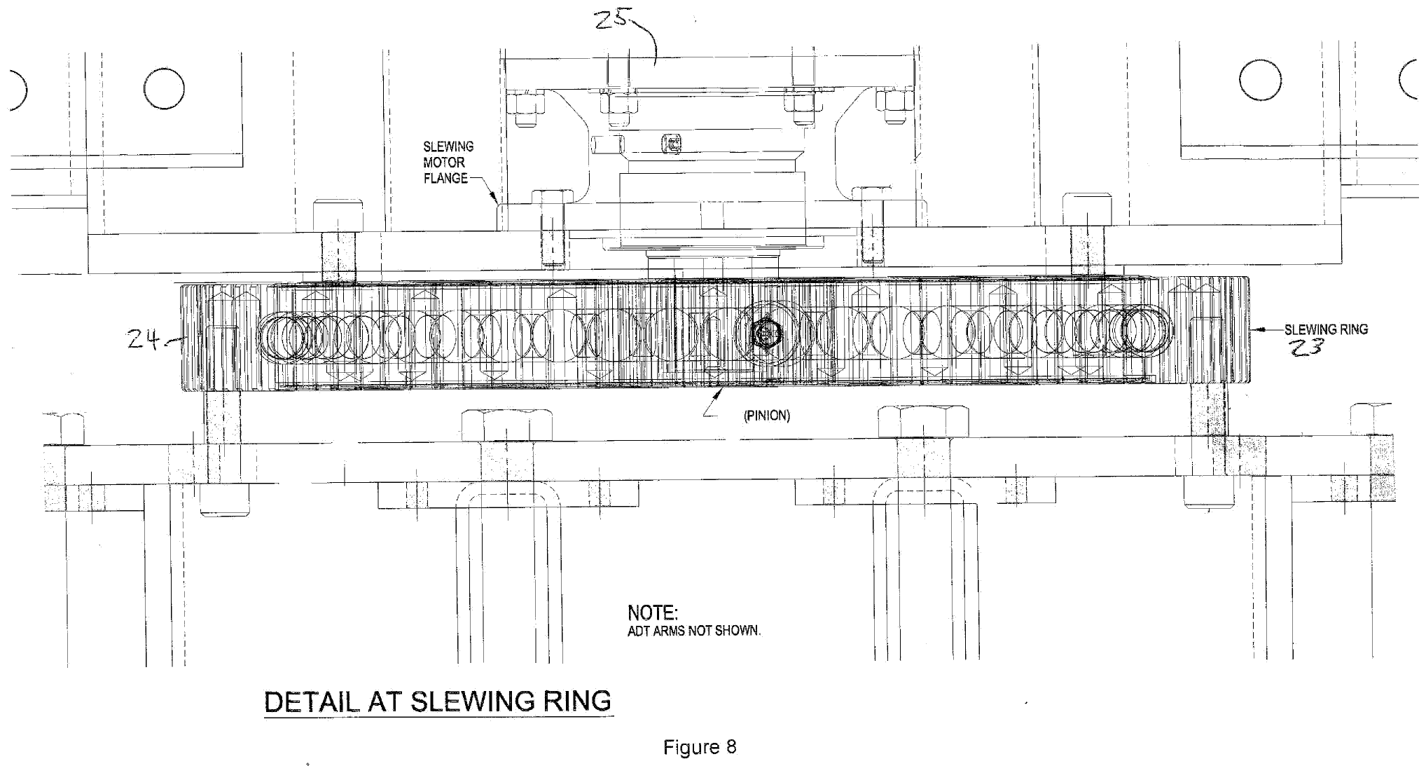

As illustrated by FIGS. 6, 7A-7C, and 8, turntable 20 comprises turret 22 which includes slewing ring 23 affixed thereto. FIG. 6 generally shows the turntable apparatus in a view that doesn't reveal details about the turret and slewing ring. Those details are illustrated in FIG. 7A (which is a side elevation view), FIG. 7B (which is a plan view looking vertically downward from reference line B), and FIG. 7C (which is a plan view looking vertically downward from reference line A). FIG. 8 shows additional details for the slewing ring and motor configuration.

Slewing ring 23 includes gear teeth which cooperate with a driving gear attached to a driving mechanism, such as an electric motor. In the embodiment shown, slewing ring 23 is attached to the outer surface of the turret assembly and is configured as a pinion type gear 24 driven by one or more motors 25 also disposed around the outside of the turret assembly. Alternatively, slewing ring 23 may be attached to the inner surface of the turret assembly and driven by one or more motors disposed inside the turret assembly. Turret 22 further includes means for mounting the turret assembly to a supporting structure, and means for allowing rotational movement of turret 22 with respect to said supporting structure. Typically, such a configuration includes two circularly shaped plates joined together by a pivot pin, with bearings disposed between the plates so as to facilitate rotational movement between these plates. One of said plates is attached to said support structure and remains stationary with respect thereto, while the other plate rotates around said pivot pin. The plate which rotates has disposed on its upper surface means for attaching main tower 40. Boom tower 60 and balancing tower 80 may each also be pivotally attached to this same means, or they may alternatively be pivotally attached to main tower 40.

Located around the outer circumference of turntable 20, and disposed in a spaced apart relationship thereto, is circularly shaped track 26. As illustrated in FIG. 7B, this track may be comprised of a plurality of modular sections 27 and assembled by joining them together in and end-to-end relationship using appropriate fastening means, such as, for example, track splice plates 28. Utilizing this type of modular arrangement allows construction of a circular track which is larger in diameter and heavier in weight than would fit into an elevator or stairwell, and would be moveable by manpower alone, if it was formed as a single piece. Track 26 is further configured so that the plane which contains the upper surface thereof is parallel to the plane which contains the rotating bearing plate of turret 22 (as described above).

At least one support arm 29 extends radially outwardly from turret 22, configured so that the inner end thereof is attached to turret 22 and the outer end thereof is attached to at least one caster wheel 30 which rolls on said upper surface of track 26. In the embodiment shown in FIG. 7C, eight such support arms are employed. These support arms are further disposed so that the bending forces experienced by turret 22 are transferred through said arms and said associated caster wheels to circular track 26. In one embodiment, the lower surface of circular track 26 is configured so that it also forms a plane which is parallel to the plane containing the upper surface of track 26, and at least one support arm extends radially outwardly from turret 22 and is configured so that the inner end thereof is attached to turret 22 and the outer end thereof is attached to at least one caster wheel which rolls on said lower surface of track 26. In this embodiment, turret 22 is further restrained from bending forces which are trying to lift upwardly the associated portion of turret 22.

By this mechanism, the moment arm of resistance to said bending forces is significantly increased, thereby allowing a relatively small diameter turret to sustain force levels that would heretofore require a much larger turret diameter. This improvement is significant in applications where the turret must be located on the roof of a building. As described above, for those applications, the turret and associated components must be small enough to fit in stairways or elevators, and they must be light enough for workers to be able to lift them and maneuver them to the roof top. In the embodiment illustrated, the circular track is comprised of modular sections which can be separately transported to the roof top and then assembled there. All of the associated components may also be formed as modular elements which are small enough and light enough to facilitate transport to the roof area for assembly at that location. The turret itself may even be formed with handles which allow workers to hold onto it.

In some applications, it might be desirable for the assembly of this invention to be moveable on the roof top itself. In that case, the inventive apparatus includes means for providing such movement, connected to the support structure for turntable 20. In one embodiment, this means comprises one of the types of trolley systems where one or more trolleys are connected to said support structure and one or more trolley rails are connected to the building.

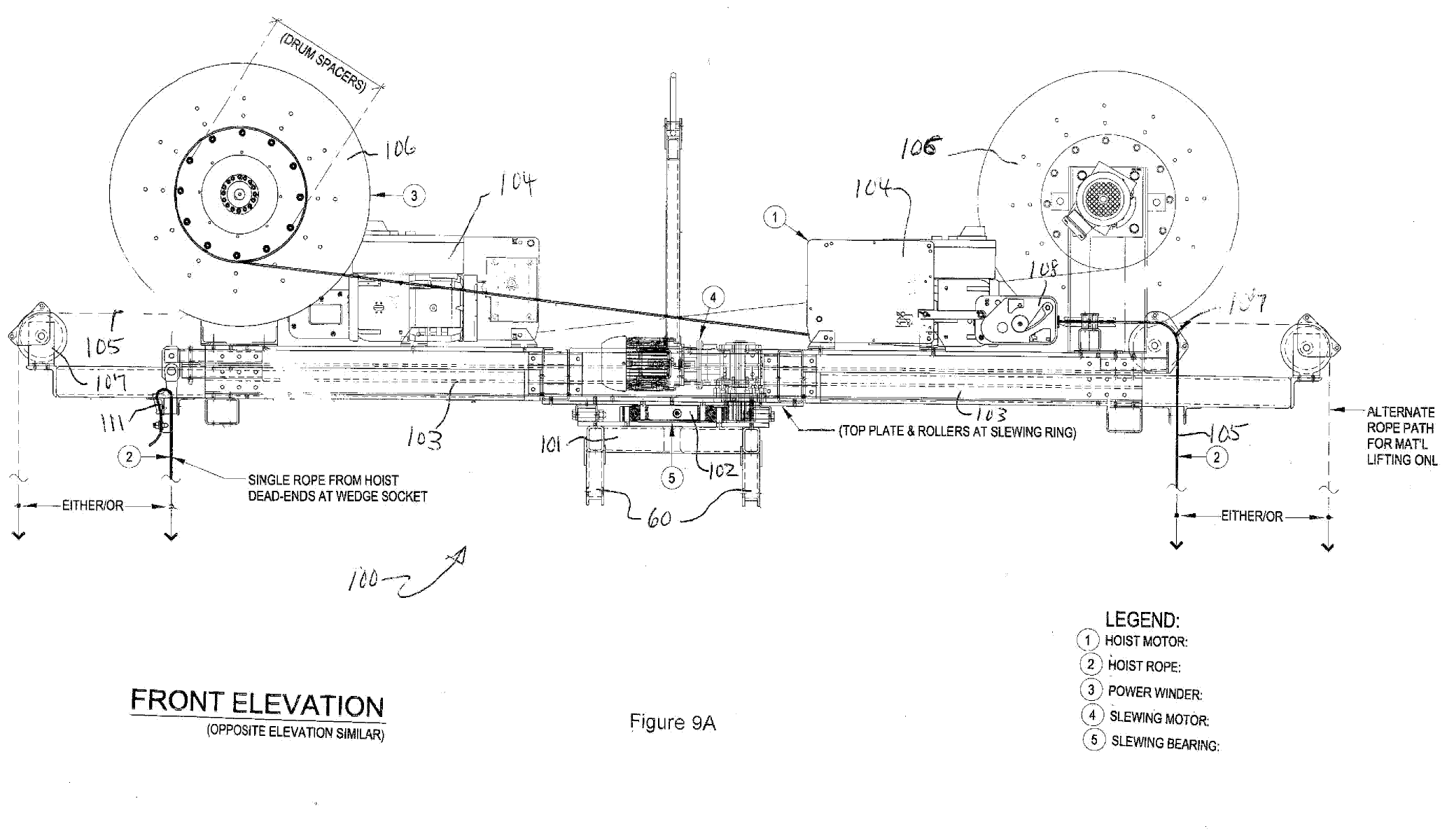

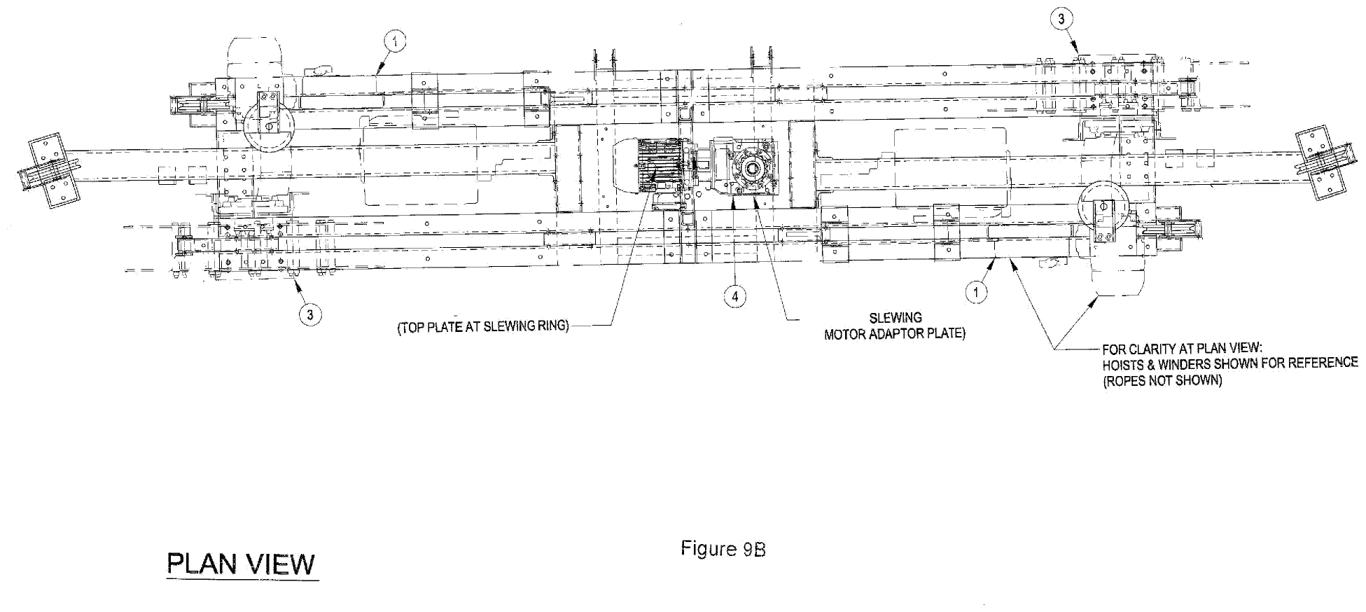

Referring now to FIG. 9A, at the end of boom tower 60 which is opposite the end thereof where boom tower 60 is attached to turntable 20, cathead 100 is pivotally attached to boom tower 60 by means of pivot points 121, which are similar to those described above which allow boom tower 60 to pivot in relationship to turntable 20 and main tower 40. These pivot points are attached to cathead support structure 101 which may be comprised of any suitable materials. In a particularly useful embodiment, cathead support structure 101, like main tower 40, boom tower 60, and balancing tower 80, is assembled from the structural members and modular beam system shown in U.S. Pat. No. 8,347,580 issued to Gregory L. Beeche.

Attached to support structure 101 is turntable 102 which is similar in construction and function to turntable 20. Turntable 102 comprises a similar arrangement of a turret which includes a slewing ring affixed thereto. This slewing ring includes gear teeth which cooperate with a driving gear attached to a driving mechanism, such as an electric motor. The slewing ring may be attached to the outer surface of the turret assembly and may be configured as a pinion type gear driven by one or more motors also disposed around the outside of the turret assembly. Alternatively, the slewing ring may be attached to the inner surface of the turret assembly and driven by one or more motors disposed inside the turret assembly. Similar to turret 22, the cathead turret also further includes means for mounting the turret assembly to cathead supporting structure 101, and means for allowing rotational movement of the cathead turret with respect to said cathead supporting structure 101. Typically, such a configuration includes two circularly shaped plates joined together by a pivot pin, with bearings disposed between the plates so as to facilitate rotational movement between these plates. One of said plates is attached to said cathead support structure and remains stationary with respect thereto, while the other plate rotates around said pivot pin. If needed to meet the strength requirements of a particular application, turntable 101 may also include a circularly shaped track, support arms, and caster wheels, all arranged in a similar configuration to that described above in conjunction with turntable 20.

The plate which rotates has disposed on its upper surface means for attaching cathead cross beam 103, with the plane containing the horizontal axis of cathead cross beam 103 being generally parallel to the plane containing said upper surface. In the cathead's “neutral” position, the longitudinal axis of cathead cross beam 103 is generally disposed at a perpendicular angle to the longitudinal axis of boom tower 60. Upon activation of the driving mechanism for turntable 102, cathead cross beam 103 rotates leftward or rightward and the angle between the longitudinal axis thereof and the longitudinal axis of boom tower 60 changes correspondingly. In this manner, the longitudinal axis of cathead cross beam 103 may be aligned with the outer edge surface of the structure for which access is being provided.

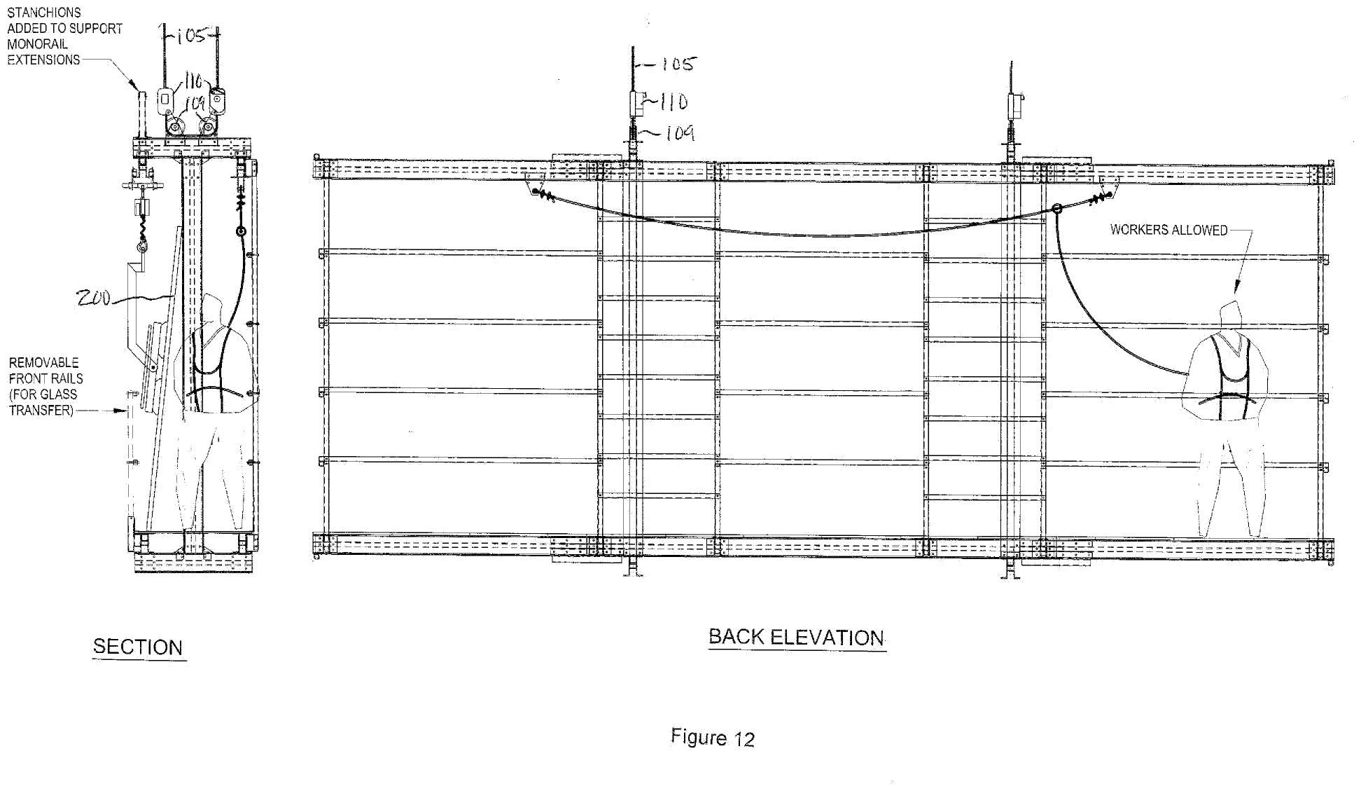

Mounted on cathead cross beam 103 is means for lifting and lowering at least one load item. In the embodiment illustrated in FIGS. 9A, 9B, 11A, and 11B, said means comprises at least one hoist motor 104 which winds or unwinds cathead cable 105, hoist drum 106 which stores the wound cable, at least one cathead sheave 107 which serves to change the direction of travel of cable 105 from an essentially horizontal direction to an essentially vertical direction, and means for attaching cable 105 to said load item. In one embodiment, hoist motor 104 comprises a traction pulling electrical hoist, and cable 105 comprises a continuous braided wire rope. Preferably, hoist motor 104 is of the type which allows selection of the hoist speed, with the capability of lifting twice as much load weight at half of the winding speed which may be used for the lesser load weight. Also preferably, two sets of these components are employed, located at opposite ends of cathead cross beam 103. Then the two corresponding means for attaching cable 105 to the load item may be spaced apart, and the two hoist motors may be operated simultaneously to lift or lower the load item. Such an arrangement provides resistance to rotational movement of the load item, as well as resistance to movement of the load item about its horizontal axis, while said load item is being lifted or lowered.

As an added safety feature, a “blocstop” type of cable monitor may be disposed between hoist motor 104 and sheave 107, as illustrated by blocstop 108. Blocstop 108 is configured so that it monitors the speed with which cable 105 passes therethrough, and if that speed exceeds a predetermined threshold, blocstop 108 acts as a brake which stops the cable from further movement. By this mechanism, cable movement at the speed expected while hoist motor 104 is winding or unwinding is allowed, but cable movement at a faster speed is stopped. Hence, if hoist motor 104 fails and the load item starts to fall, blocstop 108 will be activated, cable 105 will be stopped from further movement, and the load item will be prevented from falling to the ground.

For even greater safety, the means for attaching cable 105 to said load item includes at least one load sheave 109 which is attached to said load, and at least one blocstop 110 which monitors the speed with which cable passes therethrough, in the same manner as described above for blocstop 108. Preferably, two such sheaves 109 and blocstops 110 are employed at each attachment to the load item, in the configuration shown in FIG. 11A. Additionally, cable 105 is routed so that it passes from cathead sheave 107, through one set of load sheave 109 and blocstop 110, then onward through the second set of load sheave 109 and blocstop 110, and then back up to cathead cross beam 103, where it is attached to said cross beam 103 by any suitable means. In the embodiment illustrated in FIG. 9A, cable 105 is attached to cross beam 103 by means of wedge socket 111. With cable 105 being routed through blocstops in this manner, the load item will not fall to the ground even if the cable breaks. Referring to FIG. 11A, if cable 105 breaks between cathead sheave 107 and load sheave 109 along the portion of cable 105 designated by reference numeral 150, cable 105 will start to pass through blocstops 110 at a speed greater than that which triggers said blocstops to stop further cable movement. As a result, the portion of cable 105 which is designated by reference numeral 151 will be clamped to the load item by at least one of blocstops 110, thereby preventing the load item from falling to the ground. Conversely, if cable 105 breaks between wedge socket 111 and load sheave 109 along the portion of cable 105 designated by reference numeral 151, cable 105 will again start to pass through blocstops 110 at a speed greater than that which triggers said blocstops to stop further cable movement. As a result, the portion of cable 105 which is designated by reference numeral 150 will be clamped to the load item by at least one of blocstops 110, again preventing the load item from falling to the ground.

The load item being lifted or lowered may be either an object which needs to be moved or a basket from which workmen can access the structure being worked on. When the load item is a workmen basket, it is preferable that two sets of load sheaves 109 and blocstops 110 are employed, located at horizontally opposite ends of basket 112 in a spaced apart relationship from each other, in the manner illustrated by FIG. 11B. At each end of the basket, cable 105 is routed so that it passes from cathead sheave 107, through one set of load sheave 109 and blocstop 110, then onward through the second set of load sheave 109 and blocstop 110, and then back up to cathead cross beam 103, where it is attached to said cross beam 103 by any suitable means, such as by wedge socket 111. As described above, with cable 105 being routed through blocstops in this manner, the associated end of basket 112 will not fall very far even if the cable breaks on either side of blocstops 110. In the inventive arrangement, one portion of the cable always remains attached to both the basket and to the cathead cross beam. And, by using this arrangement at both ends of the basket, the basket will remain sufficiently level that workmen won't fall out of the basket if some portion of the cable fails.

The above-described arrangement is particularly beneficial for applications where workmen safety regulations issued by the Occupational Safety and Health Administration (OSHA) or state and local governments are in effect. Those regulations typically require that a worker who is at risk for falling off the structure must be tethered to that structure. However, those regulations allow the workmen to be tethered to the basket they are in (rather than the structure itself) while being raised or lowered, if that basket is configured as illustrated in the figures. Essentially, the basket shown is attached to the cathead cross beam by two lifting devices (rather than a single lifting device). Furthermore, the basket is attached by the equivalent of four separate cables. In the manner illustrated, these safeguards provided by the inventive apparatus meet or exceed the applicable OSHA requirements.

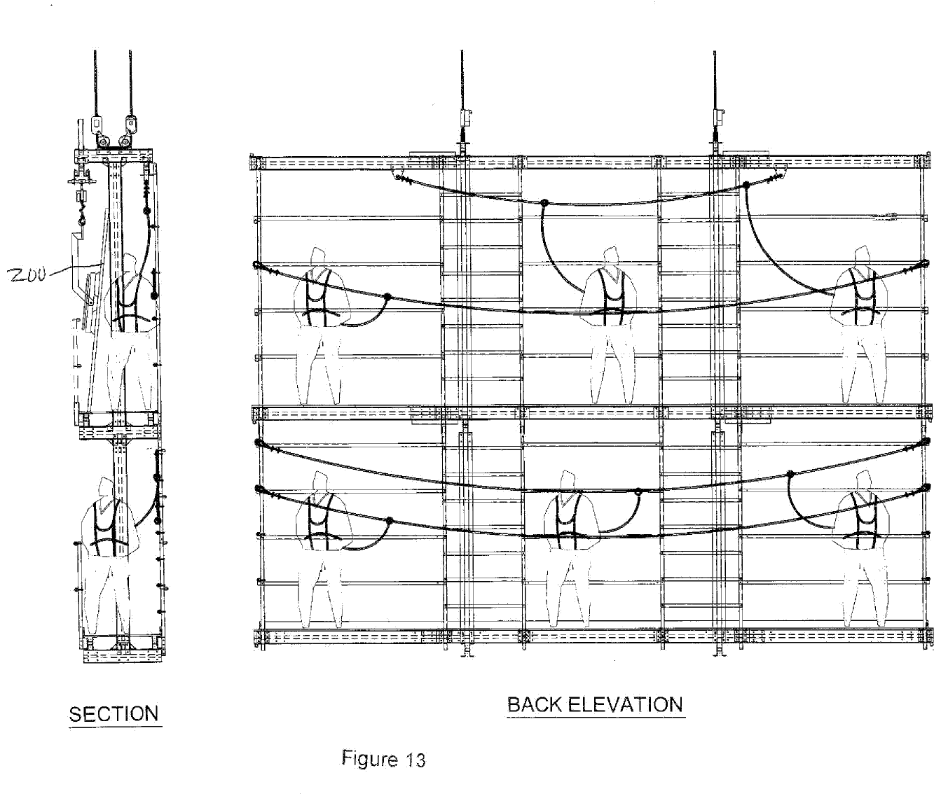

Basket 112 may be comprised of any suitable materials, in any suitable configuration. In a particularly useful embodiment, basket 112 is assembled from the structural members and modular beam system shown in U.S. Pat. No. 8,347,580 issued to Gregory L. Beeche. Using these components, the basket itself can even be formed as one or more modular units, and then fastened together as a basket assembly. The single unit shown in FIG. 11B can be extended horizontally in either direction, by adding one or more modular units to either horizontal end of the single basket, as illustrated in FIG. 12. Similarly, the single unit shown in FIG. 11B can be extended vertically, by adding one or more modular units to the bottom of the single basket, as illustrated in FIG. 13. And, of course, modular basket units could be added to the single basket in both the horizontal and the vertical directions, as illustrated in FIG. 13.

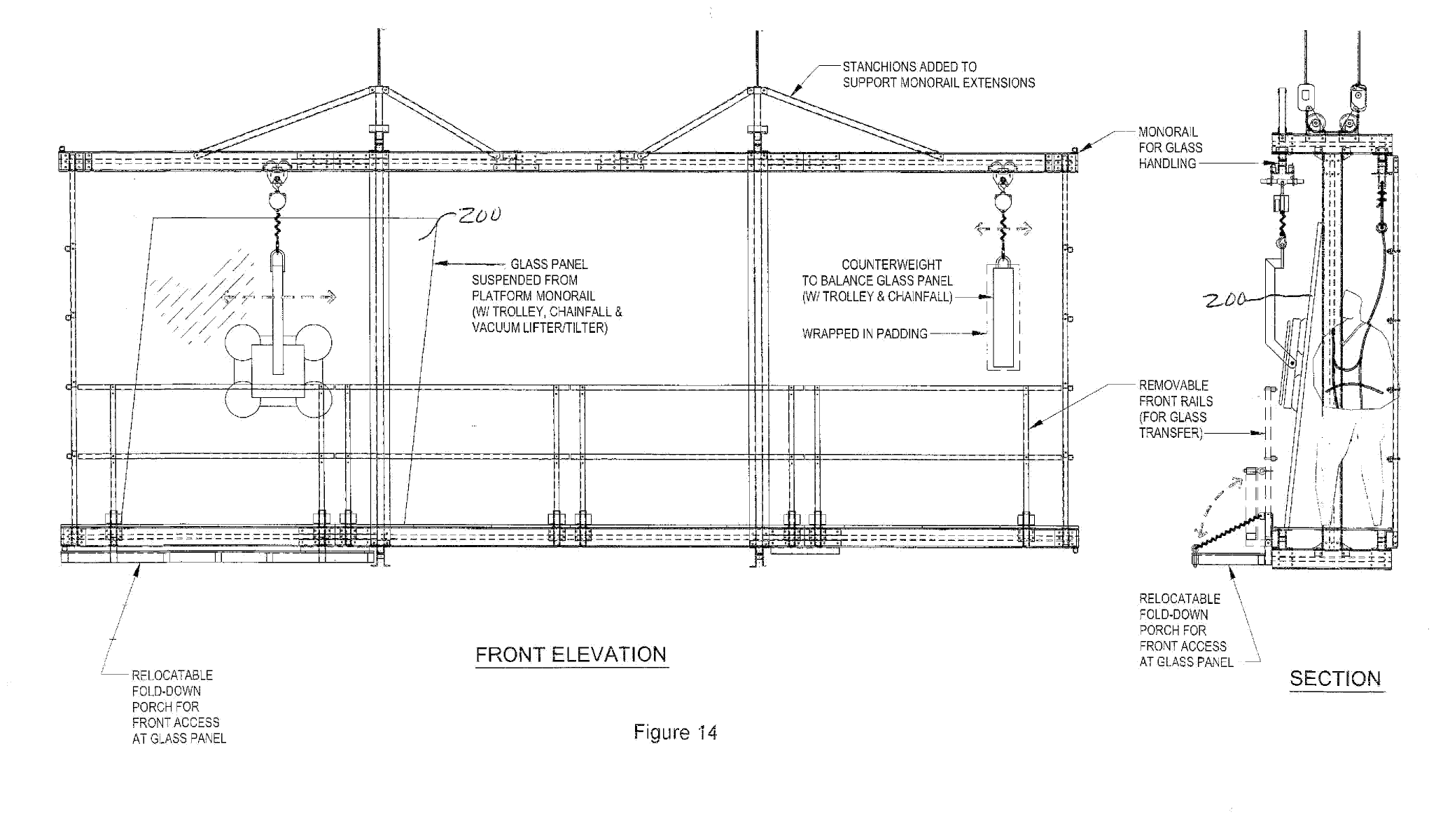

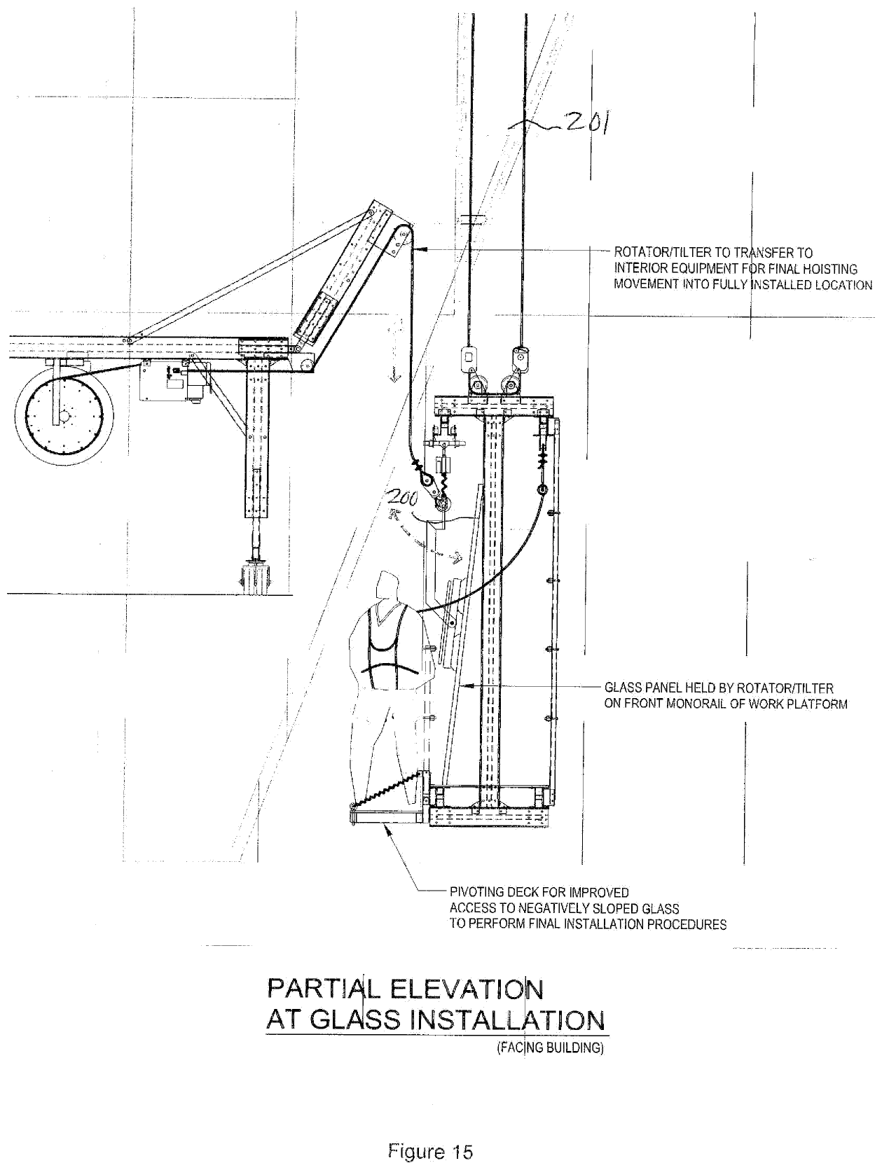

Basket 112 may further comprise means for receiving, maneuvering, and/or installing building components, such as glass façade sections. One such means is illustrated in FIGS. 11A, 12, 13, 14, and 15. In the embodiment shown, glass section 200 is first transferred from structure 201 to basket 112. It is then maneuvered within basket 112 to the desired position (usually one which results in a balanced weight distribution for basket 112), for movement of basket 112 to a different portion of structure 201, where glass section 200 is to be installed on structure 201. Finally, glass section 200 is transferred from basket 112 to the installation location. A worker riding in basket 112 can control all of these tasks and movements. Any suitable means may be employed for these panel movements. Those shown in the figures include foldable booms, cables, pulleys, and hoists employed to move the panel from the structure to the basket; cables and lifting mechanisms to transfer the panel from the structure's panel handling apparatus to the basket's panel handling apparatus; moveable counterweights to balance the load forces on the basket while this transfer is being made; and monorails, associated trolleys, and pulling mechanisms to move the panel to the desired positions within the basket for each stage of the process.

Additionally, the inventive apparatus can accommodate those occasions where it is not necessary to raise or lower basket 112, but is instead desirable to raise or lower one or more other load items using one or more of hoists 104. In that situation, basket 112 may be raised all the way up to cathead cross beam 103 and attached thereto so that is suspended therefrom. Any suitable means may be employed for this task.

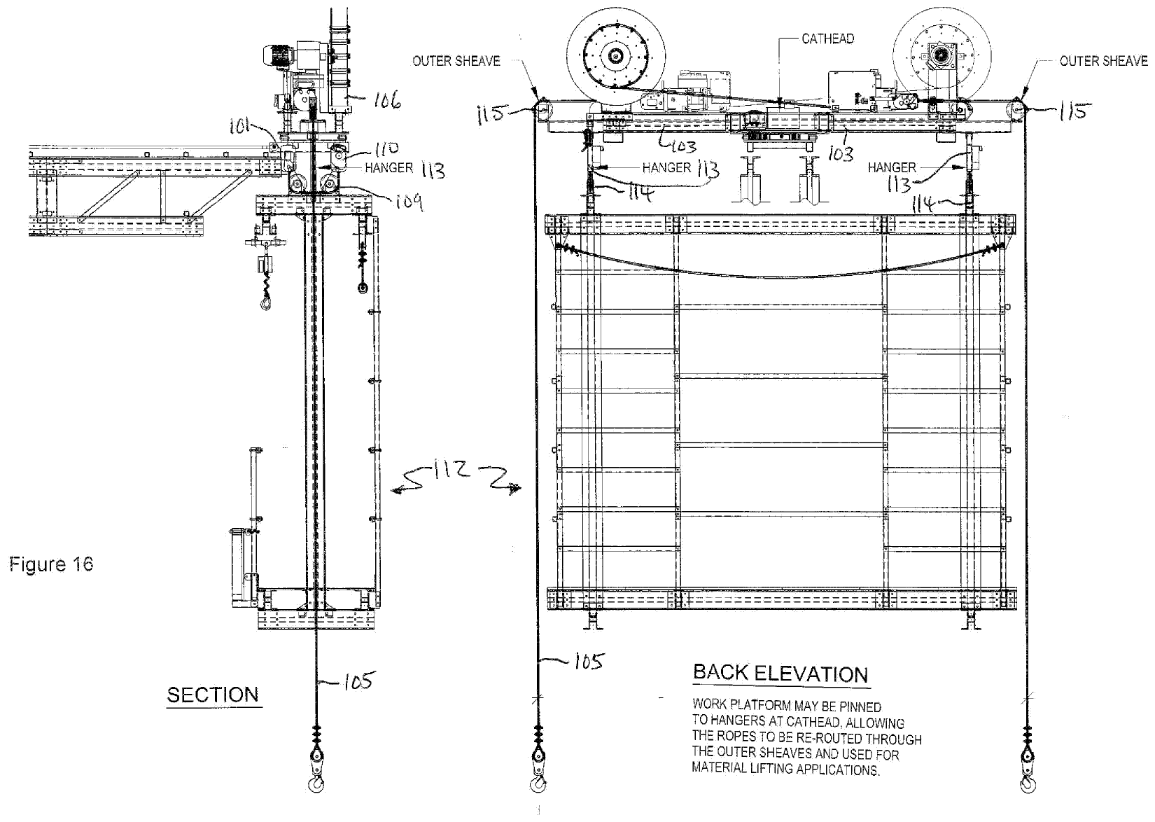

As illustrated in FIG. 16, one convenient means for doing so comprises one or more cathead hangers 113 affixed to the bottom of cathead cross beam 103, and one or more cooperating basket tabs 114 affixed to the top of basket 112. Hangers 113 and tabs 114 are each further disposed so that they contain openings therethrough which may be aligned with each other when basket 112 is properly positioned. A fastening means, such as a bolt and nut or pin and clip, may then be inserted through each aligned opening, thereby attaching basket 112 to cathead cross beam 103 in a suspended orientation. With basket 112 so attached, cable 105 may be detached from wedge socket 111, and said cable may be removed from load sheave 109 and blocstop 110 attached to basket 112, as well as cathead sheave 107. Cable 105 may then be routed to instead pass through auxiliary sheave 115 and be connected to means for attaching cable 105 to a load item. For some loads, it may be sufficient to remove cable 105 from only one end of basket 112 in this manner. For loads where additional lifting capacity is needed, or where resistance to rotational twisting of the load is desired, or where displacement of the load about its horizontal axis is a concern, cable 105 may be removed from both ends of basket 112. The cable removed from the second end may be re-routed in the same manner as described above for the first end, and both hoist motors and associated cables may be used simultaneously to lift the load involved.

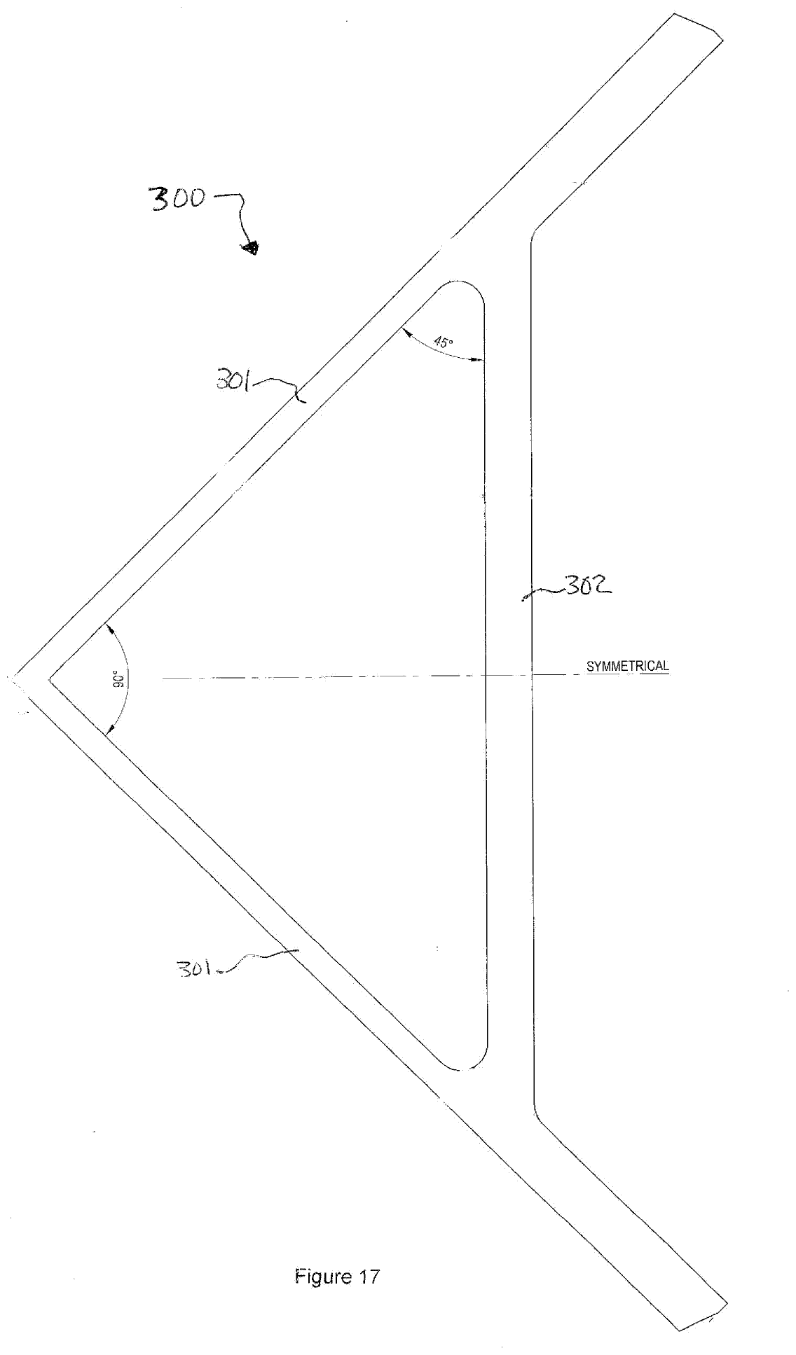

In the alternative embodiments illustrated in FIGS. 17-24, any one or all of main tower 40, boom tower 60, and balancing tower 80 may be constructed using beam element 300 shown in FIG. 17. In operation, these towers are subjected to both vertical load forces and twisting deforming forces. For any given situation, either the corresponding strengths provided by each tower must be sufficient to withstand such forces, or appropriate additional bracing must be added.

It is known that a cylindrically-shaped tube provides equal strength in the vertical and horizontal directions, and has excellent resistance to twisting forces. As such, it typically does not require any bracing to meet strength requirements; instead, the thickness of the tube wall and/or the diameter of the tube can be increased to the point where the desired strengths are achieved. However, most scaffolding applications do not require equal amounts of horizontal and vertical strength, and a cylindrical design is therefore inefficient in that the member includes more metal material in certain locations than is necessary. Furthermore, the cylindrical shape of the member requires the use of special, non-standard accessories for attaching other items to the tube.

A square-shaped or rectangularly-shaped tube provides a much better shape for attaching accessory components, while retaining much of the resistance to vertical load and twisting forces which is characteristic of a cylindrically shaped tube. However, a square-shaped or rectangularly-shaped tube presents its own difficulties with respect to attaching the members to like members and to other components, including difficulty in accessing the interior of such tubes in order to fasten such components.

The inventive structural member illustrated in FIG. 17 provides a solution to these problems. As shown therein, beam element 300 is comprised of a pair of planar side elements 301, with the two-dimensional cross-section of each said plane being shaped as shown in the drawing, and the depth of each plane extending along the length of the beam element (in the third dimension, into the paper). Side elements 301 are further disposed so as to be symmetrical with each other, and are joined together at their corresponding edges at a 90 degree angle, so that the planes containing side elements 301 are perpendicular with respect to each other.

At least one planar diagonal element 302 connects side elements 301 to each other at locations on each which are spaced apart from the edge locations where side elements 301 are joined at a 90 degree angle. The two-dimensional cross-section of diagonal element 302 is shaped as shown in the drawing, and the depth of the plane extends along the length of the beam element (in the third dimension, into the paper). In the embodiment illustrated in FIG. 17, these connection locations are the same for both side elements 301, resulting in a beam element 300 which is completely symmetrical about the symmetry axis shown. However, in other embodiments, other, non-symmetrical connection locations may be chosen. In the symmetrical embodiment shown, diagonal element 302 forms a 45 degree angle with each of side elements 301. Using non-symmetrical connection locations would allow the angles between diagonal element 302 and the respective side elements 301 to be either increased or decreased.

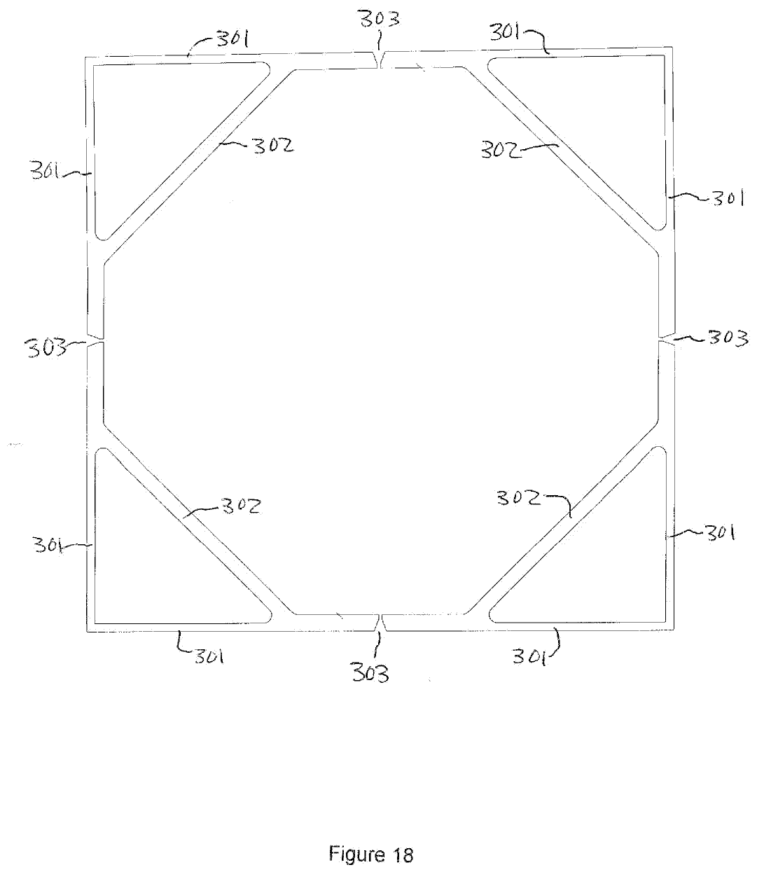

Arranging side elements 301 and diagonal element 302 in the symmetrical fashion illustrated in FIG. 17 facilitates the modularity of use for beam element 300. In the particularly useful embodiment shown in FIG. 18, four of beam elements 300 are configured so as to form a box beam for which the outer surface thereof has a square-shaped cross section. In such an arrangement, the four corners where side elements 301 meet at a 90 degree angle form the four corners of the exterior surface of the box beam. Likewise, the coplanar surfaces of adjacent side elements 301 form the sides thereof. Each diagonal element 302 forms an integrated web-like bracing member which significantly enhances the rigidity of each corner of the box beam, thereby providing significantly increased resistance to torsional twisting forces acting on the beam. These symmetrical features of the assembly provide equal load strength in both the vertical and horizontal directions, and equal resistance to twisting forces in both directions. In these aspects, the assembly approximates the characteristics of a cylindrically shaped tube.

In the embodiment shown in FIG. 18, the edge of side element 301 which is opposite the edge thereof that forms part of the 90 degree angle is shaped so that, when said edge is adjacent to the corresponding edge of an adjoining beam element 300, a substantially v-shaped channel 303 is formed. In order to fasten beam elements 300 to each other, these channels may be filled with weld material, either as discrete spot welds or as a continuous weld that extends along the length of channel 303.

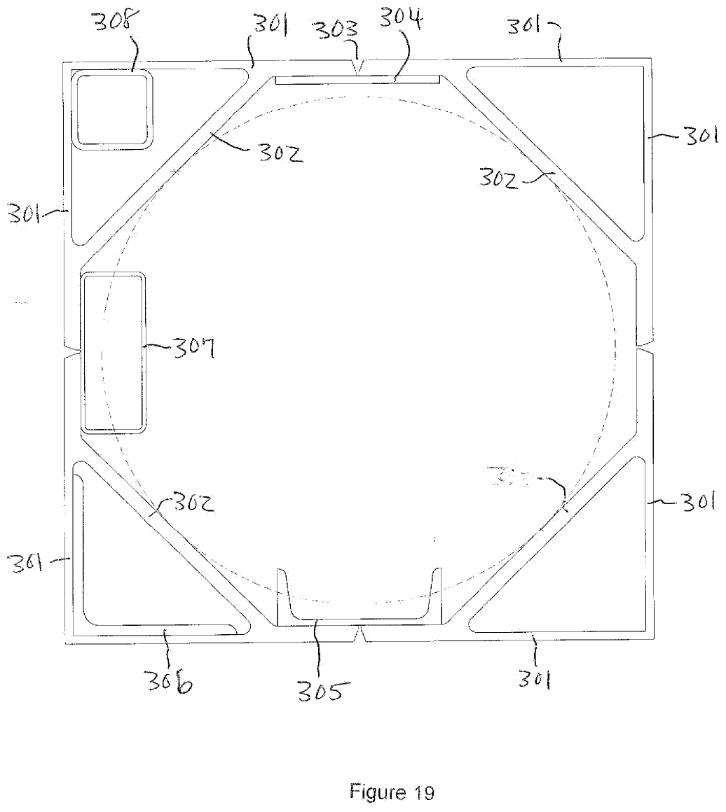

Alternatively, beam elements 300 may be fastened to each other by other suitable means. As illustrated in FIG. 19, such means may include at least one piece of bar stock 304 fastened to the interior of the box beam, at a location opposite to where channel 303 is formed. Separated pieces of bar stock may be distributed along the length of the box beam, or a single piece may extend along the entire length. In other embodiments, U-shaped member 305 or rectangularly-shaped tube 307 may be employed in place of bar stock 304, and similarly may be distributed along the length of the box beam either as discrete pieces or as a continuous piece.

For some applications, it might be desirable to add accessory structures to the box beam assembly, for such purposes as adding strength or rigidity to a particular corner thereof or facilitating attachment of other components to the box beam. For example, L-shaped element 306 may be disposed so that the vertex of its 90 degree angle is located adjacent to and abuts the vertex of the 90 degree angle formed by side elements 301, and so that each of its legs is located adjacent to and abuts the interior of the corresponding portion of the respective side element 301. Again, this element may also be distributed along the length of the box beam either as discrete pieces or as a continuous piece. Similarly, rectangularly-shaped tube 308 may be disposed so that the exterior surface of one of its corners is located adjacent to and abuts the interior surface of the corner formed where side elements 301 form their 90 degree angle, and so that the two planar outer surfaces of tube 308 which form said corner are located adjacent to and abut the interior of the corresponding portions of the respective side elements 301. Also similarly, tube 308 may be distributed along the length of the box beam either as discrete pieces or as a continuous piece. For either of these embodiments, attachment of the respective additional element to the abutting portions of side element 301 (by any suitable means) serves as “bracing” for the associated corner of beam element 300, resulting in increased rigidity of that corner and correspondingly increased resistance to twisting forces. Depending upon the strength needed or the particular components which are to be added to the exterior of the box beam, more than one of the foregoing items may be utilized at the same time. This flexibility in configuration allows the inventive box beam to satisfy the requirements of a wide variety of applications. Moreover, when that application is finished, the added items may be removed, so that the box beam represents the basic building block once again.

In addition to providing means for fastening together multiple beam elements 300 into a box beam assembly, and providing means for adding strength and/or rigidity to the assembled box beam, each of bar stock 304, U-shaped member 305, L-shaped element 306, rectangularly-shaped tube 307, and square-shaped tube 308 may be employed to facilitate attachment of other components to the box beam. At the particular location on the exterior of the box beam where it is desirable to attach such a component, any one of these five items may added to the interior of the box beam, in the manner illustrated in FIG. 19. Suitable openings are formed in the corresponding side element 301 at that location, and matching openings are formed in the surface of the chosen accessory which lies along that portion of that side element, at the same location. The chosen accessory and the corresponding side element are further configured so that the fasteners used to attach said additional component to the box beam may be inserted through these matched openings and thereby utilized to fasten all three items together. Such fasteners may conveniently comprise commercially available threaded bolts and matching nuts, pins and clips, etc. For each of accessory items 304-308 utilized in this manner, the pulling force on the side wall of element 301, created by the fastener, is spread over a larger surface area, thereby accommodating larger such pulling forces without failure.

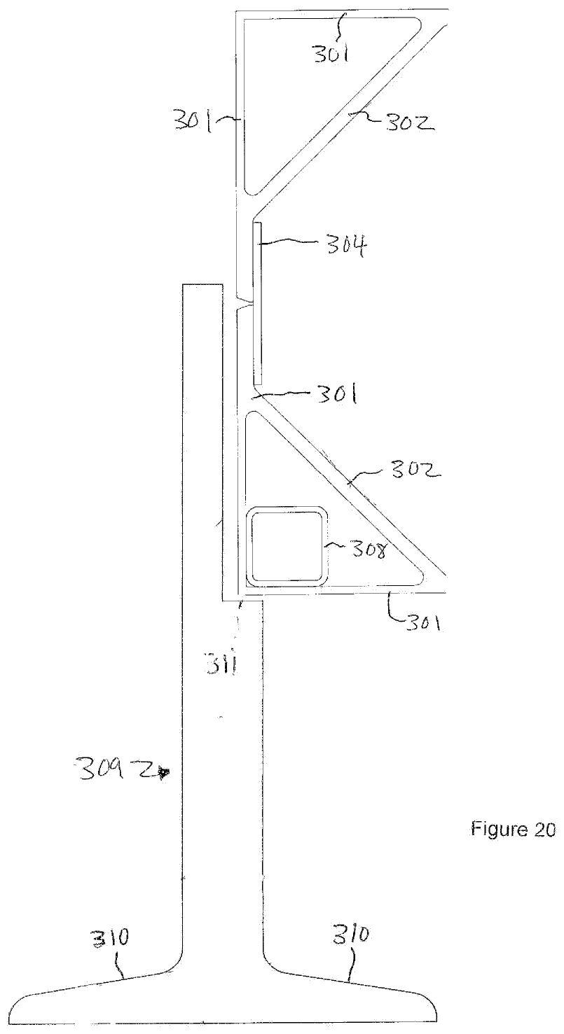

Many different types of additional components may be attached to the box beam in accordance with the foregoing description. They may be either “standard” commercially available items which have been used for other purposes, or “custom” ones specifically configured to have features which cooperate with the inventive box beam. An example of the latter type is illustrated in FIG. 20. For building access applications, it is often desirable to utilize a track and trolley arrangement to transport items from one location to another. As shown in FIG. 20, the track component of this system may be attached directly to the inventive box beam, using the fastening configuration described above. Track 309 generally has the shape of a conventional !-beam, with the top horizontal portion of the “I” removed. Additionally, the bottom horizontal portion of the “I” is shaped so that uppermost surfaces 310 slope downwardly and outwardly with respect to each other. With surfaces 310 disposed in this manner, a trolley assembly rolling along the length of track 309 will tend to align itself with the central vertical axis of track 309. For additional resistance to forces on track 309 which act to horizontally swing the bottom of track 309 with respect to the box beam, shoulder portion 311 may be formed in the vertical portion of the “I” at a location which is adjacent to the corresponding lower corner of the box beam. Then, when track 309 is attached to the box beam using the fastening method described above (using, for example, bolts passing through the upper portion of track 309, side element 301, bar stock 304, and/or square-shaped tube 308 shown in the drawing), the upper surface of shoulder 311 abuts against the adjacent outer surface of the box beam, thereby effectively restraining track 309 from rotational movement about its vertical axis.

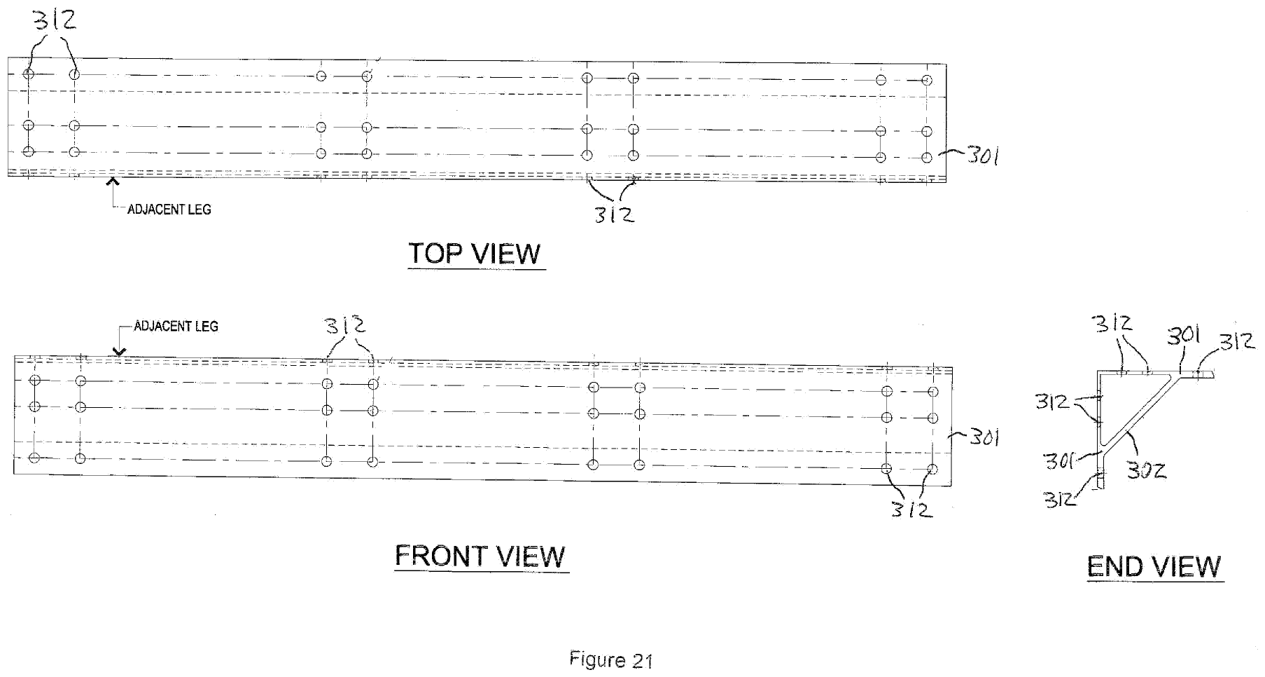

For convenience and modularity, the fastening system described hereinabove may include a plurality of openings 312 formed in side elements 301, located and spaced apart as shown in FIG. 21. In one embodiment, openings 312 are configured in a symmetrical arrangement, both with respect to their locations along side elements 301 (as illustrated in the SIDE VIEW shown in FIG. 21), and with respect to their locations along the length of beam element 300 (as illustrated in the TOP VIEW and the FRONT VIEW shown in FIG. 21). In such a configuration, the modularity of beam element 300 is such that it does not matter whether the left end or the right end, of the beam length shown in the TOP VIEW and the FRONT VIEW of FIG. 21, is used for a given connection, or whether the END VIEW shown in FIG. 21 is rotated 90 degrees.

However, although modularity is enhanced by using the symmetrical arrangements just described, the exact locations and spacing of openings 312 can be varied, if necessary to meet the requirements of a particular application. In general, openings 312 are located so that fasteners may be inserted therethrough and also through correspondingly located openings in such items as bar stock 304, U-shaped member 305, L-shaped element 306, rectangularly-shaped tube 307, and square-shaped tube 308. As described hereinabove, each of these items may be utilized to either join together multiple beam elements 300 into a box beam assembly, provide means for adding strength and/or rigidity to the assembled box beam, or facilitate attachment of other components to the box beam.

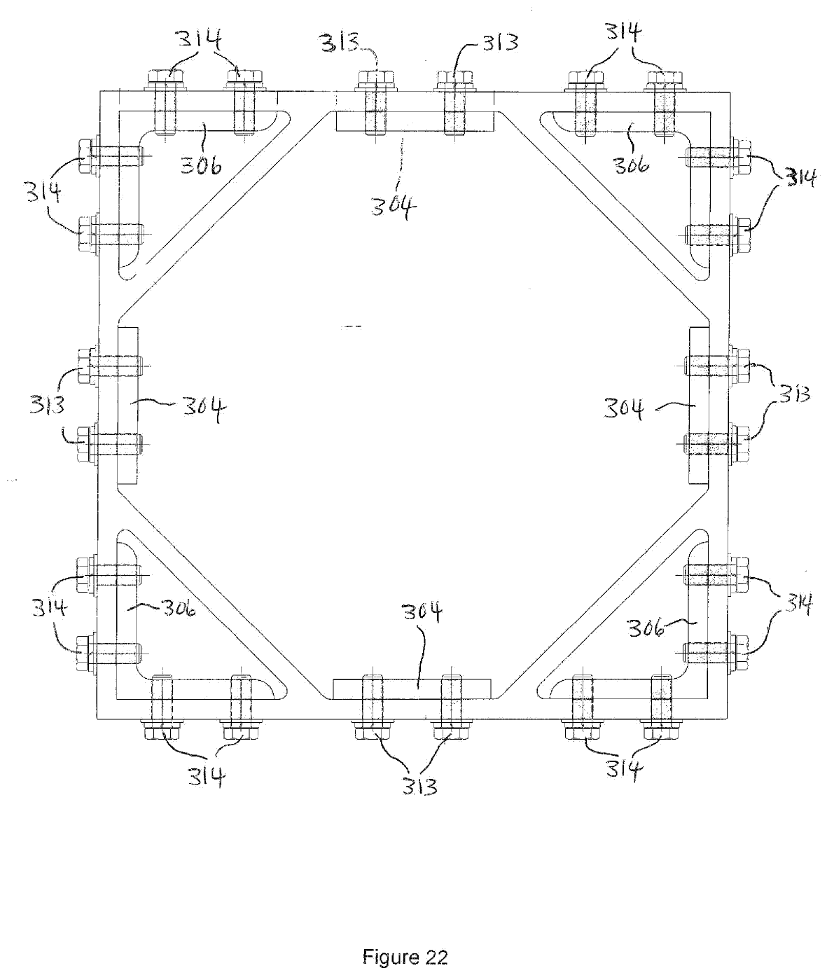

In the particularly useful embodiment illustrated in FIG. 22, fastening bolts 313 extend through openings 312 and through the correspondingly located openings in bar stock 304. In the embodiment shown, each opening in bar 304 is further disposed so as to form a threaded portion, with the threads formed thereby matching the diameter and pitch of the threaded portion of bolt 313. This type of threaded portion may conveniently be formed by a tapping operation which utilizes a tap and die tool. In such a configuration, this threaded portion of bar stock 304 acts as the “nut” in a bolt and nut fastener, and bolt 313 may simply be threaded into said threaded portion of bar stock 304 to fasten together the parts involved. Alternatively, the threaded portion of the opening in bar stock 304 may be omitted, bolt 313 may be inserted through said opening, and a standard fastening nut may be screwed onto bolt 313. If this arrangement is used, then bolt 313 may be inserted in either direction (from the outside to the inside or from the inside to the outside). Also, although only bar stock 304 is shown in FIG. 22, any one or more of U-shaped member 305, L-shaped element 306, rectangularly-shaped tube 307, and square-shaped tube 308 could be used in place of bar stock 304, using the same types of openings and fasteners.

The openings through L-shaped element 306 shown in FIG. 22 may employ the same concepts described above for bar stock 304. Said openings may be disposed so as to form similar threaded portions, with the threads formed thereby matching the diameter and pitch of the threaded portion of bolt 314, and bolts 314 may simply be threaded into said threaded portions of element 306 to fasten together the parts involved. Alternatively, the threaded portions of the openings in element 306 may be omitted, bolts 314 may be inserted through said openings, and standard fastening nuts may be screwed onto bolts 314. Although separate labeling has been used for bolts 313 and 314 to point out that they need not be the same, for most applications it will be convenient to use the same bolts for both.

Regardless of which joining item is used, whether it be bar stock 304, U-shaped member 305, L-shaped element 306, rectangularly-shaped tube 307, or square-shaped tube 308, it may be placed so that the end thereof is flush with the end of the associated beam element 300. In such a configuration, the joining item is only employed to join together multiple beam elements 300; for example, it may join together four beam elements 300 into a square-shaped box beam assembly, as described hereinabove. Alternatively, the joining item may be placed so that the end thereof extends beyond the end of the associated beam element 300, in a configuration where the joining item overlaps the end of an adjoining beam element 300 which is disposed in an end-to-end relationship with the first beam element 300. In this configuration, the joining item may serve to connect two or more beam elements 300 in an end-to-end assembly which increases the effective length of the overall beam member. Of course, the same joining item may be used to also join together multiple beam elements 300 into a full box beam assembly of the type shown in FIG. 22, or at least a portion thereof, thereby simultaneously serving both functions. Furthermore, placement of the joining items may be selectively chosen so that a given joining item connects beam elements 300 together side-to-side, end-to-end, or both. For example, in the embodiment shown in FIG. 22, L-shaped element 306 could be used to connect beam elements together end-to-end, whereas bar stock 304 could be used to connect them together side-to-side, end-to-end, or both.

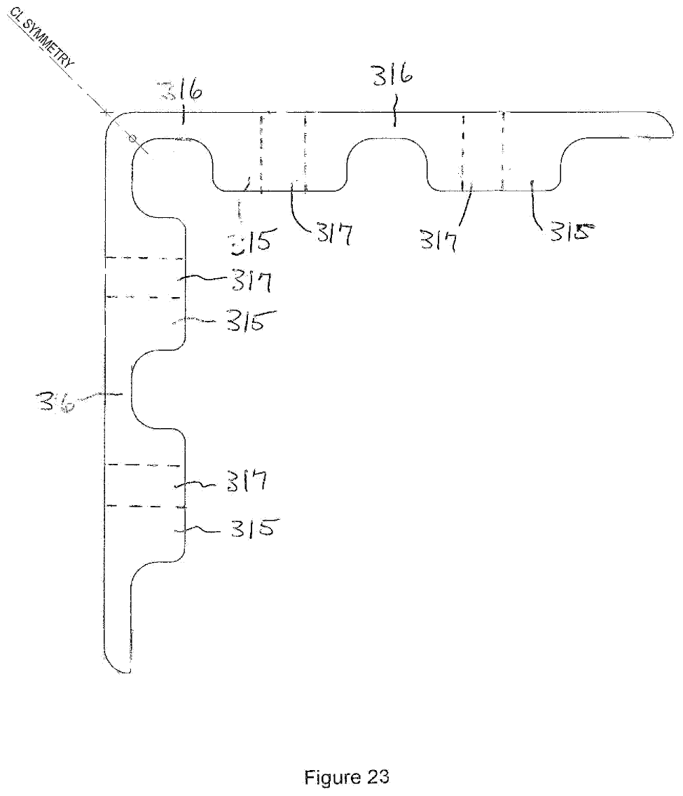

For applications where the joining item also serves as the “nut” for the fastening bolt, as previously described, FIG. 23 illustrates a preferred embodiment for L-shaped element 306. To provide additional length for the threaded portions of openings 317 in L-shaped element 306, through which fastening bolts 314 are inserted, and thereby to increase the strength of the fastening mechanism, L-shaped element 306 is further configured so that the thickness thereof at the locations indicated by reference numerals 315 is increased as compared to the thickness at the locations indicated by reference numerals 316. This increased thickness essentially provides a thicker, and stronger, “nut” for the bolt and nut fastener. Although the same result could be achieved by uniformly increasing the thickness of all portions of L-shaped element 306, doing so would result in wasted material. Such thickness typically is not needed in the other portions of element 306. The embodiment shown in FIG. 23 therefore makes a much more efficient use of raw material, while simultaneously providing greater fastening strength. Of course, this same feature could also be incorporated into each of bar stock 304, U-shaped member 305, rectangularly-shaped tube 307, and square-shaped tube 308.

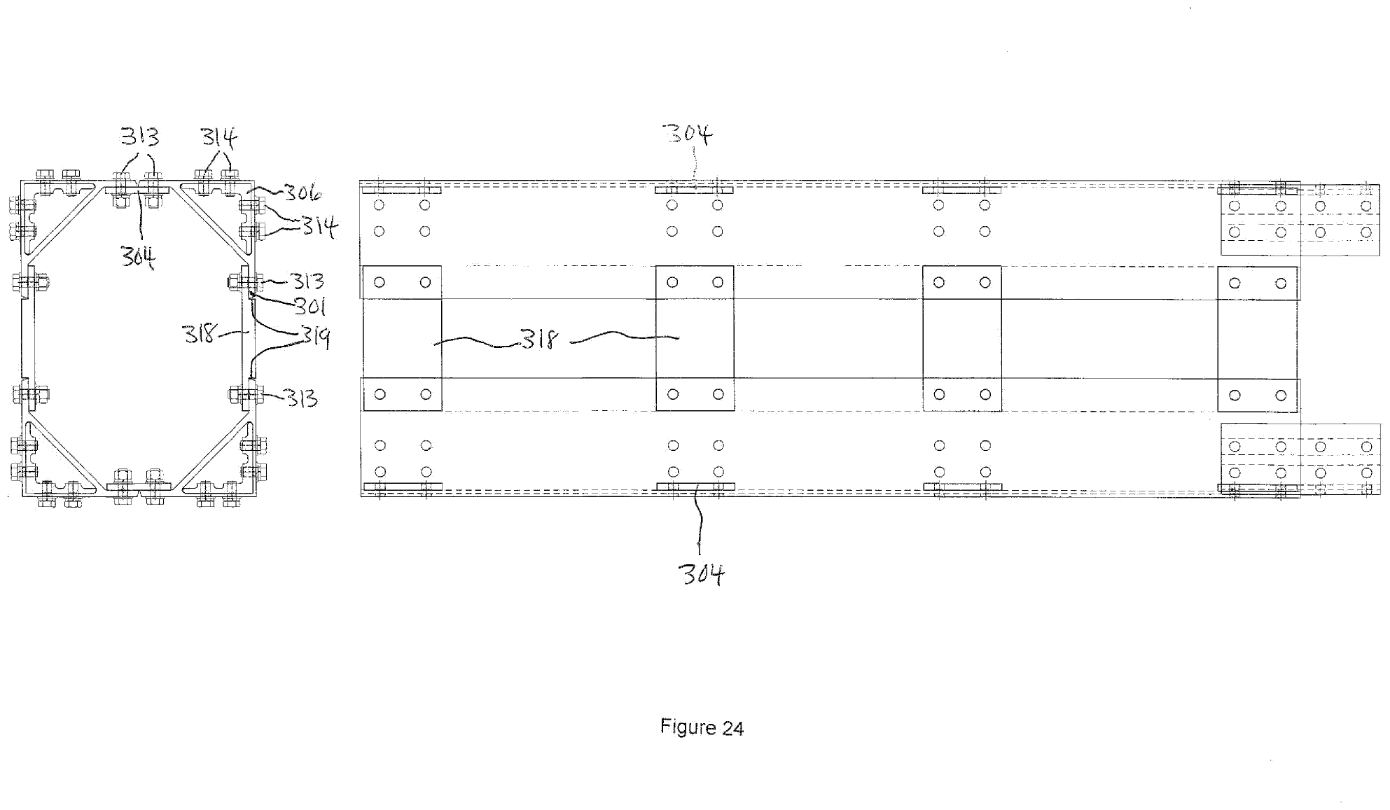

For some applications, it might be desirable for the cross-section of the box beam to be rectangular rather than square. For such applications, bar stock 304 shown in FIG. 22 may be replaced by spacer plate 318, as illustrated in FIG. 24. In its most basic embodiment, plate 318 may simply be a wider version of bar stock 304, with this extra width being the feature which adds spacing between the opposing ends of side elements 301. In the preferred embodiment shown in FIG. 24, spacer plate 318 includes a section having increased thickness, which section is located between the opposing ends of side elements 301. This increased thickness section is further configured so that two shoulders 319 are formed, one at each location where spacer plate 318 contacts the adjacent end of one of side elements 301. When spacer plate 318 is fastened to the two opposing ends of side elements 301 (for example, by bolts 313), each shoulder 319 abuts against the corresponding end of side element 301. Such an arrangement serves to both help secure beam elements 300 in a spaced apart configuration and to further restrain spacer plate 318 from rotational movement about its vertical axis (i.e., from pivoting about any one of bolts 313). In turn, these two effects further increase the rigidity of the assembled box beam. Similarly to the other joining means described hereinabove, multiple spacer plates 318 may be separated and distributed along the length of the box beam, as shown in FIG. 24, or spacer plate 318 may comprise a single piece which extends along the entire length of the beam.

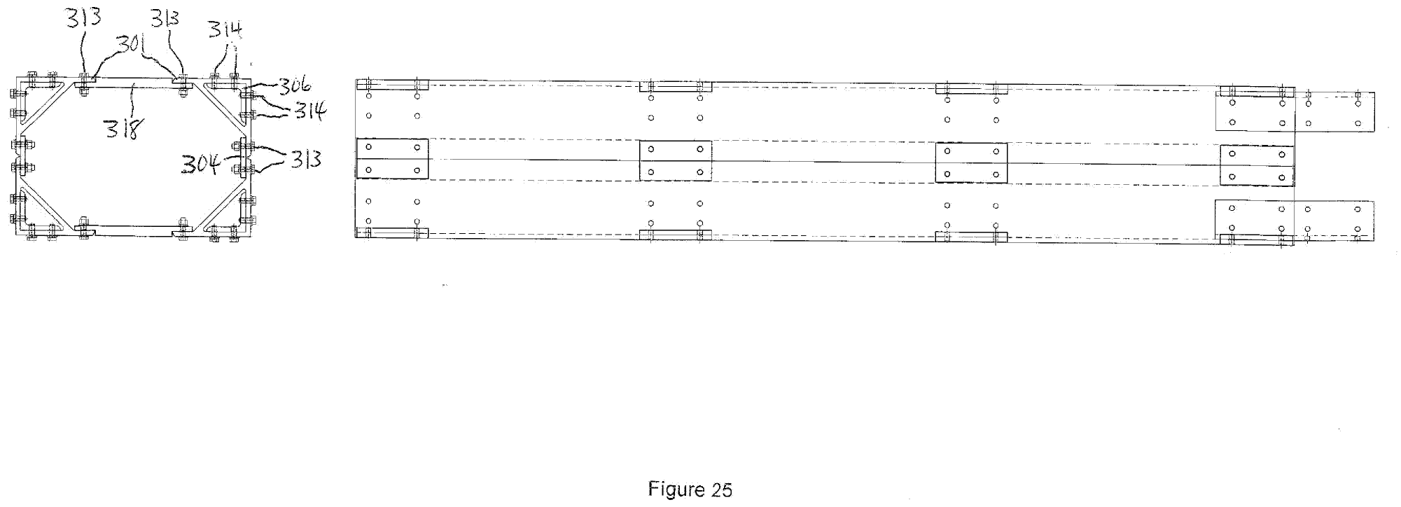

FIG. 25 illustrates that the above-described arrangement may also be employed to increase the size of the assembled box beam in the “width” direction, similarly to the manner shown in FIG. 24 for increasing the size of the assembled box beam in the “height” direction. Of course, for box beams which utilize the preferred symmetrical version of beam element 300, these “width” and “height” directions are reversible by simply rotating the assembled box beam by 90 degrees about the longitudinal axis of the box beam. Doing so results in the “height” direction becoming the “width” direction, and vice versa.

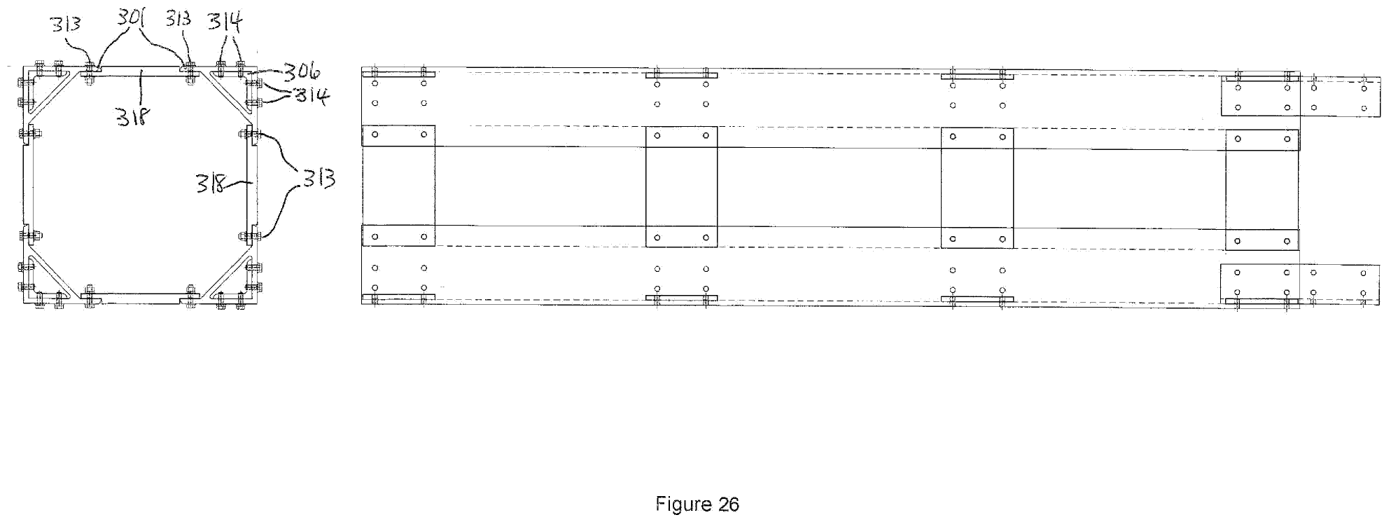

Finally, FIG. 26 illustrates that, for applications where it is desirable to do so, the size of the assembled box beam may be increased in both the “height” and the “width” directions. In such an embodiment, spacer plates 318 may be utilized to join together all four of beam elements 300, in the arrangement shown. Again, any two of these beam elements may be joined by using multiple spacer plates 318 which are separated and distributed along the length of the box beam, as shown in FIG. 26, or a single piece which extends along the entire length of the beam.

It can be seen from the foregoing discussion that the building access system of the present invention provides the ability to move workers and materials to any location adjacent to the exterior of the structure involved, without needing to disassemble and reassemble, or to otherwise re-configure, the access assembly. The inventive system allows construction and maintenance workers to safely perform their tasks on all portions of the building's exterior, at any height between ground level and the top of the building, with minimal interruption required to move the assembly or to include hoisting of materials. The assembly may additionally be formed from modular components which can be specifically chosen and configured to have sufficient reach, span strength, and torsional rigidity which match the requirements of a particular application.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

The invention claimed is:

1. An improved building access system, comprising:
a turntable having an upper surface and a lower surface;
a main tower attached to said upper surface of said turntable;
a boom tower pivotally attached to said turntable and disposed so as to form an angle with said main tower;
a balancing tower pivotally attached to said turntable and disposed so as to form an angle with said main tower;
means for changing said angles between said main tower and, respectively, said boom tower and said balancing tower; and
a cathead pivotally attached to the end of said boom tower which is opposite the end thereof attached to said turntable, disposed so as to form an angle with said boom tower.

2. The invention of claim 1 further comprising pressure sensing devices located and disposed so as to measure the pressure at each mounting point where said main tower is attached to said turntable.

3. The invention of claim 1 further comprising at least one leveling rod attached at one end thereof to said turntable and attached at the other end thereof to said cathead, disposed so that, as said boom tower is raised upwardly and said angle between said main tower and said boom tower decreases in value by an associated amount, said angle between said cathead and said boom tower decreases in value by the same amount.

4. The invention of claim 1 wherein said turntable comprises:
a turret;
a slewing ring with a plurality of attached gear teeth affixed to said turret; and
a driving mechanism having gear teeth which cooperate with said slewing ring gear teeth and disposed so that activation of said driving mechanism provides rotation of said turret.

5. The invention of claim 4 further comprising:
means for mounting said turret to a support structure; and
means for providing rotational movement of said turret with respect to said support structure.

6. The invention of claim 5 wherein said mounting and rotating means comprises:
a first circularly shaped plate, attached to said support structure and generally disposed in a horizontal plane;
a second circularly shaped plate, attached to said turret and generally disposed in a horizontal plane, and further disposed in a spaced-apart relationship with said first plate;
at least one bearing element disposed between said first and second plates so as to facilitate rotational movement between said plates; and
a pivot pin configured so as to hold together said first and second plates and said bearing element.

7. The invention of claim 6 further comprising:
a circularly shaped track located around the outer circumference of said turntable, disposed in a spaced apart relationship thereto and configured so that the plane which contains the upper surface thereof is parallel to the plane which contains said second plate; and
at least one support arm extending radially outwardly from said turret, configured so that the inner end thereof is attached to said turret and the outer end thereof is attached to at least one caster wheel disposed in rolling relationship to said upper surface of said track 26.

8. The invention of claim 7 wherein each said support arm is further disposed so that the bending forces experienced by said turret are transferred through said arm and said associated caster wheel to said circular track.

9. The invention of claim 1 wherein said angle changing means comprises:
at least one sheave attached to said boom tower;
at least one sheave attached to said balancing tower;
at least two pulleys attached to said main tower;
at least two cable winders attached to said main tower;
at least one cable disposed through said boom tower sheave and attached to a first one of said cable winders, so that activation of said winder lengthens or shortens said cable length and correspondingly lowers or raises said boom tower; and
at least one cable disposed through said balancing tower sheave and attached to a second one of said cable winders, so that activation of said winder lengthens or shortens said cable length and correspondingly lowers or raises said balancing tower.

10. The invention of claim 1 wherein selected ones of said main tower, said boom tower, and said balancing tower comprise box truss assemblies.

11. The invention of claim 10 further comprising a tensioning cable which is attached at one end thereof to one of the box corners of the longitudinal end of said tower, and further disposed in a diagonal direction to the opposite corner of the adjacent box corner of said tower.

12. A cathead assembly useable for hoisting and pivoting a basket assembly, comprising
a cathead support structure;
a turntable attached to said support structure; and
means attached to said support structure for hoisting and lowering said basket assembly;

13. The invention of claim 12 wherein said turntable comprises:
a turret;
a slewing ring with a plurality of attached gear teeth affixed to said turret; and
a driving mechanism having gear teeth which cooperate with said slewing ring gear teeth and disposed so that activation of said driving mechanism provides rotation of said turret.

14. The invention of claim 12 further comprising:
means for mounting said turret to a cathead support structure; and
means for providing rotational movement of said turret with respect to said cathead support structure.

15. The invention of claim 14 wherein said mounting and rotating means comprises:
a first circularly shaped plate, attached to said support structure and generally disposed in a horizontal plane;
a second circularly shaped plate, attached to said turret and generally disposed in a horizontal plane, and further disposed in a spaced-apart relationship with said first plate;
at least one bearing element disposed between said first and second plates so as to facilitate rotational movement between said plates; and
a pivot pin configured so as to hold together said first and second plates and said bearing element.

16. The invention of claim 12 wherein said means for hoisting and lowering said basket assembly comprises:
at least one hoist motor attached to said cathead support structure;
at least one cable connected to said hoist motor and to said basket assembly so that activation of said hoist motor hoists or lowers said basket assembly with respect to said cathead support structure; and
at least one blocstop cable monitor disposed so that said cable passes therethrough.

17. An elongated beam member, comprising:
a pair of symmetrical planar side elements, each extending throughout the length of said beam member and disposed so that the respective planes containing said side elements are perpendicular with respect to each other and so that said side elements are joined together at their corresponding edges at a 90 degree angle; and
at least one planar diagonal element connecting said side elements to each other at locations on each which are spaced apart from said edge locations where said side elements are joined at a 90 degree angle.

18. The invention of claim 17 wherein said connection locations are the same for both of said side elements.

19. The invention of claim 17 wherein the edge of said side element which is opposite the edge thereof that forms part of said 90 degree angle is further configured so that, when said edge is adjacent to the corresponding edge of an adjoining beam member, a substantially v-shaped channel is formed.

20. The invention of claim 17 further comprising a plurality of openings formed in said side elements, located and disposed so that fasteners may be inserted therethrough and fastened to cooperating connection means.
